(19) United States
(12) Patent Application Publication
(10) Pub. No.: US 2011/0080471 A1
(43) Pub. Date: Apr. 7, 2011

(54) Hybrid method for 3D shape measurement

(75) Inventors: Zhang Song, Ames, IA (US); James H. Oliver, Des Moines, IA (US)

(73) Assignee: IOWA STATE UNIVERSITY RESEARCH FOUNDATION, INC., Ames, IA (US)

(21) Appl. No.: 12/924,765

(22) Filed: Oct. 5, 2010

Related U.S. Application Data
(60) Provisional application No. 61/249,108, filed on Oct. 6, 2009.

(51) Int. Cl. H04N 13/02; G01B 11/22

(52) U.S. Cl. 348/46; 356/627; 348/E13.074

(57) ABSTRACT

A method for three-dimensional shape measurement provides for generating sinusoidal fringe patterns by defocusing binary patterns. A method for three-dimensional shape measurement may include (a) projecting a plurality of binary patterns onto at least one object; (b) projecting three phase-shifted fringe patterns onto the at least one object; (c) capturing images of the at least one object with the binary patterns and the phase-shifted fringe patterns; (d) obtaining codewords from the binary patterns; (e) calculating a wrapped phase map from the phase-shifted fringe patterns; (f) applying the codewords to the wrapped phase map to produce an unwrapped phase map; and (g) computing coordinates using the unwrapped phase map for use in the three-dimensional shape measurement of the at least one object. A system for performing the method is also provided. The high-speed real-time 3D shape measurement may be used in numerous applications including medical science, biometrics, and entertainment.

### CROSS-REFERENCE TO RELATED APPLICATION

This application claims the benefit of Provisional Application No. 61/249,108, filed Oct. 6, 2009, herein incorporated by reference in its entirety.

### FIELD OF THE INVENTION

The present invention relates to optical imagery. More specifically, but not exclusively, the present invention relates to methods and systems for performing three dimensional (3D) shape measurement where sinusoidal fringe patterns are generated by defocusing binary patterns

### BACKGROUND OF THE PRIOR ART

For real-time 3D shape measurement, techniques based on color (Geng 1996, Harding 1991, Huang et al. 1999, Zhang et al. 2002) have the potential to reach higher speed since the color contains more information. However, the measurement accuracy is affected, to a various degree by the color of the object. Recently, one of the present inventors has co-developed a technology for high-resolution real-time 3D shape measurement (Zhang & Huang 2006a,b) by utilizing fast phase-shifting algorithms and white light sources (Huang & Zhang 2006, Zhang et al. 2007). That technique takes advantage of the single-chip DLP projector's projection mechanism, and encodes three phase-shifted fringe patterns into RGB channels of the projector, which are switched automatically and naturally by the projector. Therefore, the 3D data acquisition speed can theoretically reach the projection speed, which is typically 120 Hz. Despite the success of the technique, several major limitations are present. These include limitations associated with single connected patch measurement, smooth surface measurements and speed.

Single connected patch measurement is used by existing algorithms. The basic assumptions of the algorithms adopted have this limit (Zhang et al. 2007, Zhang & Yau 2008). Thus, it is impossible to measure multiple objects simultaneously.

“Smooth” surfaces measurements is an additional significant limitation. The success of phase unwrapping is based on the assumption that the phase difference between the neighborhood pixels is less than ¼. It is in principle impossible to measure step height objects beyond ¼ of the wavelength (Creath 1987a).

Maximum speed of 120 Hz is another significant limitation. Because the sinusoidal fringe images are utilized, at least 8-bit depth is required to produce good contrast fringe images. That is, a color image can only encode three fringe images, thus, the maximum fringe projection speed is limited by the digital video projector's maximum projection speed (usually 120 Hz).

What is needed is a method and system for overcoming these limitations and to provide for 3D shape measurement which may be applied in numerous applications.

One example of such an application which would benefit from high-speed 3D geometry techniques relates to medical imaging, and especially imaging of the heart. Optical imaging of intact hearts is a growing field that is providing insight into cardiac physiology at the organ level (Efimov et al. 2004). Visualizing 3D geometry of the heart with the corresponding optical cardiac mapping of the electrical activities is a very powerful tool for studying complex arrhythmias. Panoramic optical imaging for heart study was introduced by Lin and Wikswo (Lin & Wikswo 1999) to map the entire ventricular epicardium from three different angles around the heart. Later, more efforts were developed to this novel imaging methodology. Bray et al. proposed to reconstruct the heart geometry and texture map the optical signal onto the geometric surface for better visualization (Bray et al. 2000). Kay et al. implemented panoramic optical mapping on swine hearts (Kay et al. 2004), and Rogers et al. applied this technology in the research of ventricular fibrillation (Rogers et al. 2007). More recently, a panoramic imaging system was developed using three photo-diode arrays with high temporal resolution for research on mechanism of cardiac defibrillation (Qu et al. 2007). Later, a way to mesh the heart surface for translation of some common 3D analysis methods, and estimate the conduction velocity vector fields from the panoramic data set was developed (Lou et al. 2008). Also under development is a single, panoramic 3D imaging which relies on immobilizing the heart (Qu et al. 2007). A CCD camera is pointed at the heart and the heart is rotated to capture 20-60 images, based on this sequence of 2D images, the 3D geometry is reconstructed. However, the 3D measurement speed is slow and it is clearly not feasible to measure the motion of the heart.

Studies of large-scale wavefront dynamics, especially those during fibrillation and defibrillation, would benefit from visualization of the entire epicardial surface (Bray et al. 2000). The panoramic 3D imaging and the visualization of the heart have been demonstrated to be a very powerful tool for studying complex arrhythmias (Evertson et al. 2008, Kay et al. 2004, Lin & Wikswo 1999, Lou et al. 2008, Qu et al. 2007, Rogers et al. 2007). Because the live beating heart deforms rapidly, there is no existing 3D imaging technique can capture the geometric motion. Hence, the existing techniques require immobilization of the heart which makes it impossible to understand the mechanical function besides the electrophysiology. Thus, what is needed is an improved method for acquiring 3D dynamic geometry which can be used in studying the heart and in numerous other applications.

### SUMMARY OF THE PRESENT INVENTION

Therefore, it is a primary object, feature, or advantage of the present invention to improve over the state of the art.

It is a further object, feature, or advantages of the present invention to provide for real-time three-dimensional imaging.

It is a further object, feature, or advantage of the present invention to provide measurement speed which is significantly faster than existing high-resolution, real-time 3D shape measurement techniques.

It is a still further object, feature, or advantage of the present invention to measure step-height objects, which is not possible using prior art high-resolution, real-time 3D shape measurement techniques.

Yet another object, feature, or advantage of the present invention is to allow for simultaneous measurements of multiple objects.

It is another object, feature, or advantage of the present invention to provide a 3D imaging technique which may be used in complex applications such as measuring live heart 3D shapes accurately.

Another object, feature, or advantage of the present invention is to provide for 3D shape measurement in a manner which eliminates issues associated with nonlinear gamma effect.

A further object, feature, or advantage of the present invention is to provide for 3D shape measurement in a manner that does not require precise synchronization between a camera and a projector.

A still further object, feature, or advantage of the present invention is to provide for 3D shape measurement in a manner that does not require precise control of the exposure time of the camera, especially when a short exposure time is used.

Yet another object, feature, or advantage of the present invention is to provide for fast 3-D shape measurement which may be applied to numerous applications including medical science, biometrics, and entertainment.

One or more of these and/or other objects, features, or advantages of the present invention will become apparent from the specification and claims that follow. Different independent aspects or embodiments of the present invention may exhibit one or more of these objects, features, or advantages. No single aspect or embodiment need exhibit all of these objects, features, or advantages. The present invention is not to be limited to or by these objects, features, or advantages.

According to one aspect of the present invention, a method for three-dimensional shape measurement is provided. The method includes generating sinusoidal fringe patterns by projecting defocused binary patterns onto an object to thereby produce phase-shifted fringe patterns. The method further includes capturing images of the object with the phase-shifted fringe patterns produced thereon and evaluating the images for use in the three-dimensional shape measurement.

According to another aspect of the present invention, a method for three-dimensional shape measurement is provided. The method may include projecting a plurality of binary patterns onto at least one object and projecting three phase-shifted fringe patterns onto the at least one object. The method may further include capturing images of the at least one object with the binary patterns and the phase-shifted fringe patterns. The method may further include obtaining codewords from the binary patterns, calculating a wrapped phase map from the phase-shifted fringe patterns, applying the codewords to the wrapped phase map to produce an unwrapped phase map, and computing coordinates using the unwrapped phase map for use in the three-dimensional shape measurement of the at least one object. A system for performing the method is also provided. The method allows for high-speed real-time 3D shape measurement which may be used in numerous applications.

According to another aspect of the present invention, a method for three-dimensional shape measurement is provided which includes generating sinusoidal fringe patterns by defocusing binary patterns. This allows for very high-speed 3D shape measurement which is not achievable using conventional methods.

According to another aspect of the present invention, a system for three-dimensional shape measurement includes at least one projector, at least one camera, and at least one system processor. The system is configured to perform steps of (a) generating sinusoidal fringe patterns by projecting defocused binary patterns onto an object to thereby produce phase-shifted fringe patterns, (b) capturing images of the object with the phase-shifted fringe patterns produced thereon, and (c) evaluating the images for use in the three-dimensional shape measurement.

According to another aspect of the present invention, a system for three-dimensional shape measurement is provided. The system includes at least one projector, at least one camera, and at least one system processor. The system is configured to generate sinusoidal fringe patterns by defocusing binary patterns, projecting the sinusoidal fringe patterns onto at least one object, capturing images of the at least one object with the sinusoidal fringe patterns, and evaluating the images to provide for three-dimensional shape measurement of the at least one object. Each of the at least one projector may be a DLP projector which inherently provides for binary image generation. The system processor may include one or more GPUs.

### BRIEF DESCRIPTION OF THE DRAWINGS

FIG. 1 is a schematic diagram illustrating one embodiment of the hybrid algorithm.

FIG. 2 illustrates 3D shape measurement procedures using the hybrid algorithm.

FIG. 3 illustrates simulated results: (a)-(c) Binary patterns; (d) Codeword generated from the binary patterns; (e)-(g) Phase shifted fringe images with a phase shift of 2π/3; (h) Wrapped phase map.

FIG. 4 illustrates the combining of the codewords and wrapped phase to obtain the unwrapped phase: (a) 160th row of the wrapped phase map, the converted codeword, and the unwrapped phase map; (b) Unwrapped phase map.

FIG. 5 illustrates measurement of the complex object: (a) Testing object; (b) The coarsest binary structured image; (c) The finest binary structured image; (d) One sinusoidal fringe image.

FIG. 6 illustrates direct measurement of the complex object: Direct measurement result of the complex object. (a) Wrapped phase map from three phase-shifted fringe images; (b) Codeword map using the binary images directly; (c) Unwrapped phase map by combining (a) and (b).

FIG. 7 illustrates direct measurement result the complex object: (a) Gradient of the phase map shown in FIG. 6(a); (b) The codeword after adjustment; (c) Final unwrapped phase map.

FIG. 8 illustrates 3D geometry of the object: (a) 3D visualization; (b) 3D visualization in another viewing angle; (c) Zoom-in view.

FIG. 9 illustrates results of two separate objects simultaneously: (a) Photograph of the objects; (b) 3D result rendered in shaped mode; (c) Cross section of 240th row from top.

FIG. 10 illustrates binary structured patterns projected with a projector at different defocusing levels. Where level 1 is in focus and level 4 is severely defocused.

FIG. 11 illustrates: (a) 200^{th} row of the fringe images; (b) 200^{th} row of the phase error.

FIG. 12. Comparison between the traditional and the proposed method. (a) Phase error (RMS) under different level of defocusing; (b) Phase error without projector's gamma calibration.

FIG. 13. Measurement result of a complex sculpture with the proposed approach. (a) I1; (b) I2; (c) I3; (d) 3D shape rendered in shaded mode.

FIG. 14 illustrates one embodiment of a panoramic 3D imaging system setup. (a) 3D view of the panoramic system; (b) Top view of the system; (c) Side view of the system.

FIG. 15 provides an alternative projection for each projector to avoid the interference problem.

FIG. 16 illustrates 3D shape measurement using the proposed hybrid algorithm. (a) The coarsest binary structured image; (b) The finest binary structured image; (c) One sinusoidal fringe image; (d) The wrapped phase map; (e) The codeword map; (f) The unwrapped phase map; (g) 3D shape after converting the phase to coordinates.

FIG. 17 illustrates a pipeline of one embodiment of a high-speed 3D geometry sensing system.

FIG. 18 illustrates one embodiment of a system layout for one example of a high-speed 3D geometry sensing system.

FIG. 19 illustrates an optical switching principle of a digital micromirror device (DMD) used in the present invention.

FIG. 20 illustrates an example of the projected timing signal if the projector is fed with different grayscale value of the green image, (a) Green=255; (b) Green=128; (c) Green=64).

FIG. 21 illustrates an example of sinusoidal fringe generation by defocusing binary structured patterns. (a) shows the result when the projector is in focus; (b)-(f) show the result when the projector is increasingly defocused. (g)-(l) illustrate the 240 row cross section of the corresponding above image.

FIG. 22 is a photograph of a test system.

FIG. 23 is an example of sinusoidal fringe generation by defocusing a binary structured pattern. (a) Photograph of the object; (b) Fringe image; (c) Frequency map after Fourier transform; (d) Wrapped phase; (c) Unwrapped phase.

FIG. 24 is a 3-D plot of the measurement results shown in FIG. 24.

FIG. 25 is a captured fringe image when a conventional sinusoidal fringe generation technique is used. The top row shows typical frames and the bottom row shows one of their cross sections.

FIG. 26 is a capture fringe image when the proposed fringe generation technique is used. The top row shows typical frames and the bottom row shows one of their cross sections.

FIG. 27 is a comparison between the fringe patterns generated by the binary method and the sinusoidal method if they have different exposure time. (a) Sinusoidal method with 1/60 sec exposure time (Media 1); (b) Binary method with 1/60 sec exposure time (Media 2); (c) Sinusoidal method with 1/4,000 sec exposure time (Media 3); (d) Sinusoidal method with 1/4,000 sec exposure time (Media 4).

FIG. 28 illustrates experimental results of measuring the blade of a rotating fan at 17393 rpm. (a) Photograph of the blade; (b) Fringe image; (c) Wrapped phase map; (d) Mask; (e) Unwrapped phase map.

FIG. 29 illustrates capturing the rotating fan blade with different exposure times. (A) Fringe pattern (exposure time=80 microseconds); (b) Fringe pattern (exposure time=160 microseconds); (c) Fringe pattern (exposure time=320 microseconds); (d) Fringe pattern (exposure time=640 microseconds); (e) Fringe pattern (exposure=2,778 microseconds); (f) Phase map of fringe pattern in (a); (g) Phase map of fringe pattern in (b); (h) Phase map of fringe pattern in (c); (i) Phase map of fringe pattern in (d); (j) Phase map of fringe pattern in (e).

FIG. 30 is a schematic diagram of one example of an algorithm.

FIG. 31 illustrates experimental results of a flat white surface with panels (a), (b) showing the widest and narrowest binary patterns, panel (c) showing sinusoidal pattern, and panel (d) showing an unwrapped phase map.

FIG. 32 illustrates the 480^{th} cross section of the wrapped and unwrapped phase, panel (a) illustrates the original unwrapped phase map panel (b) illustrates the map with removed global slope of the unwrapped phase.

FIG. 33 illustrates the phase map after applying the computational framework step by step. Panel (a) shows step 1, panel (b) shows step 2, panel (c) shows step 3, panel (d) shows the 480^{th} cross section.

FIG. 34 illustrates experimental results of a complex object: panel (a) illustrates one fringe image, panel (b) illustrates 3-D raw data, panel (c) illustrates 3-D data after applying a computational framework.

FIG. 35 illustrates step-height objects can be correctly measured. Panel (a) illustrates unwrapped phase map, panel (b) illustrates a cross section.

### DETAILED DESCRIPTION

The patent or application file contains at least one drawing executed in color. Copies of this patent or patent application publication with color drawing(s) will be provided by the Office upon request and payment of the necessary fee.

### 1. Overview

The present invention includes a number of different aspects which may be independent of one another. A first aspect relates to generating sinusoidal fringe patterns by defocusing binary patterns. This allow for high resolution, super-fast 3D shape measurement. The method may be applied to numerous fields where fast 3D shape measurement is needed including, without limitation, medical sciences, homeland security, manufacturing, entertainment, and other applications. The method overcomes limitations of existing real-time 3D shape measurement technologies, especially those issues associated with image generation speed and image switching speed associated with conventional sinusoidal fringe generation. The method allows for increasing the measurement speed, expanding the measurement range, and increasing measurement capacities.

### 2. Hybrid Method for Three-Dimensional Shape Measurement

This section describes a hybrid method for three-dimensional shape measurement. This aspect of the invention utilizes binary coded structured patterns and phase-shifted sinusoidal fringe patterns to embrace the merits of a binary method: robust to noise, and those of a phase-shifting method: high resolution. The binary patterns are used to obtain the codewords which are integers to unwrap the phase map calculated from the phase-shifted fringe images. If the phase jumps and the codeword changes are precisely aligned, the phase unwrapping can be performed point by point. However, due to digital effects, the misalignments will appear. This section also addresses a technique to overcome this problem effectively. Because this technique does not require spatial phase-unwrapping step, it is suitable for measuring arbitrary step-height objects, or multiple objects at the same time. Simulations and experiments are presented to verify the performance of the proposed algorithm.

### 2.1. Introduction

With recent advancements in science and technology, 3D optical metrology becomes increasingly important for both academic research and industrial practices. Optical methods to measure 3D profiles are extensively used due to their surface non-contact and non-invasive nature, among which stereo vision (Dhond et al. 1989) is probably the most well studied one. It uses two cameras to capture 2D images from different viewing angles, relies on identifying corresponding pairs between these two images to obtain depth information, thus is difficult to perform high accuracy measurement if the object surface does not have strong texture information.

For a structured light system, instead of using the natural texture, a projector is used to replace one camera of the stereo system and actively projects coded structured patterns onto the object to assist the correspondence establishments (Salvi et al. 2004). Because the patterns are pre-defined, the matching between the projector and the camera is simplified.

Binary codification is normally used due to its simplicity and robustness to noise. However, the major drawback of the binary codification method is that it is very difficult to reach pixel-level resolution with a small number of patterns used. To increase the spatial resolution, the phase-shifting for the narrowest binary patterns are used (Sansoni et al. 1999). Because phase-shifting is used, the spatial resolution is increased. The spatial resolution is determined by the narrowest pattern used and the number of shifted patterns. However, for this technique, it is still difficult to reach pixel resolution of the camera. To further increase the spatial resolution, different variations including N-ray (Pan et al. 2004), pyramid (Chazan et al. 1995), triangular shape (Jia et al. 2007), and trapezoidal shape (Huang et al. 2005) methods have been developed. However, all of them have their limitations. It is interesting that if the projector is defocused, all these patterns will eventually become sinusoidal. Sinusoidal fringe patterns seems to be the natural choice for 3D shape measurement.

The technique that utilizes a digital video projector to project the sinusoidal fringe patterns is named “digital fringe projection”. Digital fringe projection and phase-shifting method has its obvious advantage over binary methods in that it can easily achieve pixel level resolution and high speed. Zhang and his collaborators has successfully developed a real-time 3D shape measurement system (Zhang et al. 2006 a, b). However, it has some major limitations:

Single connected patch measurement. The basic assumptions of the algorithms adopted have this limit (Zhang et al. 2006, Zhang et al. 2007). Thus, it is impossible to measure multiple objects simultaneously.

“Smooth” surfaces measurement. The success of phase unwrapping is based on the assumption that the phase difference between the neighborhood pixels is less than π. It is in principle impossible to measure step height object beyond ¼ of the wavelength (Creath 1987).

These two limitations are typical for any 3D shape measurement system using a single-wavelength phase-shifting algorithm, where a spatial phase unwrapping algorithm is required. However, the step-height objects exist everywhere and the requirement of measuring multiple objects simultaneously is very natural. To measure step height without sacrificing too much quality, two-wavelength, and multiple-wavelength phase shifting algorithms have been developed (Creath 1987, Polhemus 1973, Cheng et al. 1984, Cheng et al. 1985, Decker et al. 2003, Mehta et al. 2006, Roy et al. 2006, Warnasooriya et al. 2007, Schreiber et al. 2007).

If the longest wavelength covers the whole area, no phase unwrapping is needed, the measurement is performed point by point. That is, it can be used to measure any step-height objects and even multiple objects simultaneously. However, all these algorithms require use of sinusoidal fringe images. Moreover, the noise plays a big role for the longest wavelength fringe images. In addition, achieving the sinusoidal fringe images for the longest wavelength is sometimes difficult, such as the grating method.

One aspect of the present invention provides a hybrid method for 3D shape measurement. The binary patterns are used to obtain the codewords which are integers to unwrap the phase map calculated from the phase-shifted fringe images. If the phase jumps and the codeword changes are precisely aligned, the phase unwrapping can be performed point by point. This technique does not require traditional spatial phase-unwrapping step, thus is suitable for measuring arbitrary step-height objects, or multiple objects at the same time. However, in practice, due to sampling of the camera, and the quantization error of the projector, it is very difficult to ensure that the 2π phase jumps are precisely aligned with the codeword changes. This paper addresses an effective method to correct the incorrectly unwrapped points by computing the gradient of the phase map to relocate the 2π jump positions. Because only 5 neighborhood pixels are required, the processing error will not propagate to other areas, which is not the case for conventional phase unwrapping algorithms. Simulations and experiments are presented to verify the performance of the proposed algorithm.

Section 2.2 explains the principle of the hybrid algorithm, simulation result will be shown in Sec. 2.3. Section 2.4 describes the hardware system that is used to verify the proposed algorithm. Section 2.5 presents some experimental results, and finally, Section 2.6 provides a summary.

### 2.2. Principle

### 2.2.A. Three-Step Phase-Shifting Algorithm

Phase-shifting methods are extensively adopted in optical metrology and inspection due to its numerous merits including 1) surface non-contact and non-invasive, 2) high-resolution (pixel level), 3) high speed, 4) insensitive to spatial variations of intensity. While many phase-shifting methods have been developed including three-step, four-step, double three-step, least square, the differences between the various algorithms relate to the number of fringe images recorded, the phase shift between these fringe images, and the susceptibility of the algorithm to errors in the phase shift, environmental noise such as vibration and turbulence as well as nonlinearities of the detector when recording the intensities (Schreiber et al. 2007). Among these algorithms, three-step phase-shifting algorithm utilizes the minimum number of fringe images, thus achieve the fastest measurement speed. Even those other phase-shifting algorithms can be implemented into this approach, a three-step phase shifting algorithm with a phase shift of 2π/3 is used for its speed. The intensities of three phase-shifted fringe images are

I₁(x,y)+I″(x,y)cos [φ(x,y)−2π/3], (1)

I₂(x,y)+I″(x,y)cos [φ(x,y)], (2)

I₃(x,y)+I″(x,y)cos [φ(x,y)+2π/3] (3)

Here I′(x, y) is the average intensity, I″(x, y) the intensity modulation, and φ(x, y), the phase to be solved for. Solving Eqs. (1)-(3) simultaneously, we obtain the average intensity

I′(x,y)=(I₁+I₂+I₃)/3, (4)

the intensity modulation

$${I}^{″} ( x , y ) = \frac{\sqrt{3 {( {I}_{1} - {I}_{3} )}^{2} + {( 2 {I}_{2} - {I}_{1} - {I}_{3} )}^{2}}}{3} , \qquad ( 5 )$$

the data modulation

$${γ}^{″} ( x , y ) = \frac{\sqrt{3 {( {I}_{1} - {I}_{3} )}^{2} + {( 2 {I}_{2} - {I}_{1} - {I}_{3} )}^{2}}}{{I}_{1} + {I}_{2} + {I}_{3}} , \qquad ( 6 )$$

and the phase

$$φ ( x , y ) = {tan}^{- 1} [ \frac{\sqrt{3} ( {I}_{1} - {I}_{3} )}{2 {I}_{2} - {I}_{1} - {I}_{3}} ] \qquad ( 7 )$$

The data modulation γ indicates the data quality (contrast of fringes) with 1 being the best. This equation indicates that the phase value range obtained ranges from −π to +π. To obtain the continuous phase map, the conventional method utilizes a phase unwrapping algorithm to detect the 2π discontinuities and remove them by adding or subtracting multiples of 2π (Ghiglia et al. 1998). In other words, the phase unwrapping is essentially to find the integer numbers for each point so that

Φ(x,y)=φ(x,y)+2πm(x,y) (8)

represents the true phase value. Here capital Φ(x, y) denotes the unwrapped phase, and m(x, y) integers.

### 2.2.B. Binary Coding Algorithm

For the binary coding algorithm, only 0s and is are used to generate fringe stripes for codification. Here 0 is 0, and 1 is 255 in gray images. Even any of the existing method can be utilized for this research, a very simple method is used to verify the proposed algorithm. Assume the number of pixels that represents one period of the binary stripes is Pₖ, the sequence of binary is generated following equation

$${B}_{k} ( x , y ) = \{ \begin{matrix}0 & MOD [ INT ( \frac{2 x}{{P}_{k}} ) ] = 0 \\ 1 & otherwise\end{matrix} \qquad ( 9 )$$

Here MOD( ) operator is to the modulus after division, and INT( ) is to convert the result into integers. In this research, we also assume that

$${P}_{k} = \frac{{P}_{k - 1}}{2} ,$$

which means that the period is divided by two for the next pattern. The decoding is essentially to binarize the captured images, and obtain 0 or 1 for each pixel by setting up a threshold. The decoding is the inverse of the coding, and the codeword can be formulated as

$$CD ( x , y ) = {\sum }_{k = 1}^{N} [ {2}^{N - k - 1} {B}_{k} ( x , y ) ] \qquad ( 10 )$$

### 2.2. C. Hybrid Coding Algorithm

However, due to surface reflectivity variations, the intensity value varies drastically across the surface, and applying a fixed threshold to all image points will be problematic. To more accurately binarize the images, image normalization procedure is used. From Eqs. (4) and (5), the maximum intensity (Iₘₐₓ) and the minimum intensity (Iₘᵢₙ) can be computed for each pixel,

Iₘᵢₙ₍x,y)=I′(x,y)−I″(x,y), (11)

Iₘₐₓ₍x,y)=I′(x,y)+I″(x,y). (12)

Once we have the minimum and maximum intensity values, the binary images can be normalized following

$${B}_{k}^{n} ( x , y ) = \frac{{B}_{k} ( x , y ) - {I}_{min} ( x , y )}{{I}_{max} ( x , y ) - {I}_{min} ( x , y )} . \qquad ( 13 )$$

Then a universal threshold of 0.5 can be used to binarize the images, and Eq. (10) becomes

$$CD ( x , y ) = {\sum }_{k = 1}^{N} [ {2}^{N - k - 1} {B}_{k}^{n} ( x , y ) ] . \qquad ( 14 )$$

Assume P0 is chosen the number of pixels horizontally (for vertical stripes) or (for horizontal stripes), the codeword is unique for the whole image. In the meantime, if we assume the smallest pitch number if PN, and the phase-shifted fringe images with a pitch number of ^{P}₂^{N}. The 2π period of fringe images will be precisely aligned with the shortest binary patterns, thus the m(x, y) in Eq. (8) can be determined by codeword. It means that the codewords generated by the binary patterns can be used to correct the 2π discontinuities or unwrap the phase point by point using the following equation,

Φ(x,y)=φ(x,y)+CD×2π. (15)

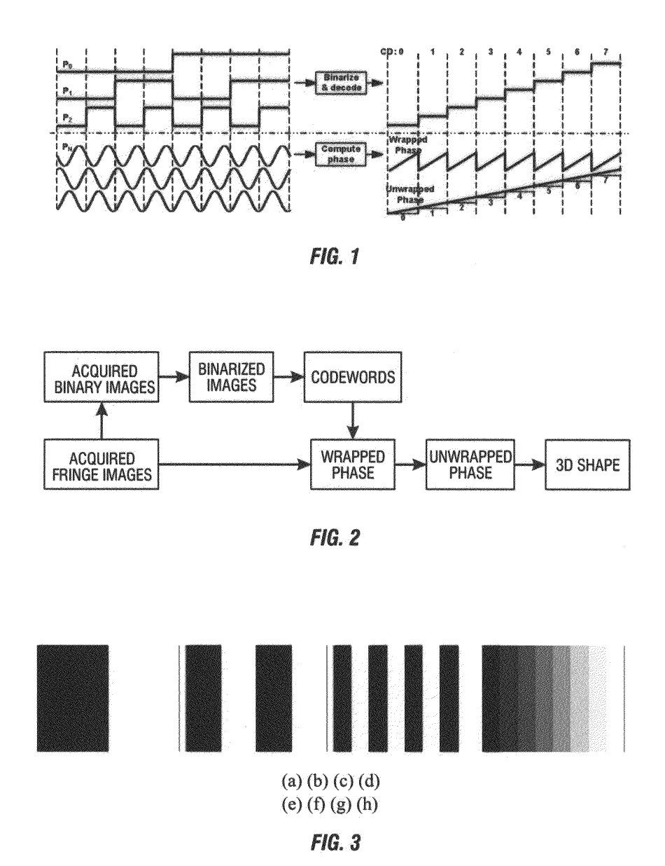

FIG. 1 illustrates the hybrid algorithm schematically and FIG. 2 shows the processing procedure. A number of binary and three phase-shifted fringe patterns are sequentially projected onto the object can captured by the camera. The codeword can be obtained from the binary patterns and the wrapped phase map can be calculated from the phase-shifted fringe patterns. Then the codewords are applied to the wrapped phase map to unwrap them. The unwrapped phase map can then be utilized for coordinate computation once the system is calibrated (Zhang et al. 2006).

### 2.3. Simulation

We first simulate the proposed algorithm and show its performance. FIG. 3 shows the binary patterns (FIGS. 3(a)-3(c)), the fringe patterns (FIGS. 3(e)-3(g)), the codeword generated by the binary patterns (FIG. 3(d)), and the wrapped phase map obtained from the fringe images (FIG. 3(h)). The image size simulated is 480×360. For this simulation, three binary patterns are used, thus the total number of codewords generated is 8. The wrapped phase map shows the 2π discontinuities. Conventionally, the wrapped phase map is unwrapped using a phase unwrapping algorithm to obtain the continuous phase map. In this research, this phase map is unwrapped using the codewords generated by the binary patterns.

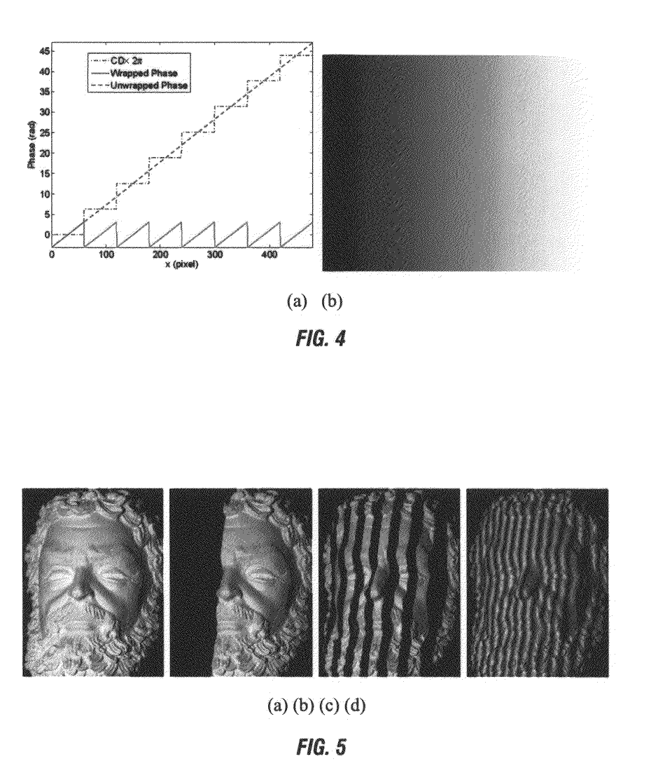

FIG. 4 shows unwrapped result. FIG. 4(a) shows the cross sections of the wrapped phase map, the codeword, and the unwrapped phase map. This figure shows that the 2π jumps is aligned with the codeword changes. Therefore, the codewords can be used to remove the 2π discontinuities. FIG. 4(b) shows the unwrapped phase map. This phase is continuous and correctly unwrapped. The simulation results demonstrate that the proposed algorithm can achieve the expected performance as to use the binary patterns to obtain the integer numbers for phase unwrapping.

### 2.4. Experimental System Setup

The experimental system is configured in the same manner as that for a previously developed real-time 3D shape measurement system (Zhang et al. 2006a,b) to demonstrate the proposed algorithm for 3D shape measurement. The whole system was calibrated utilizing the approach addressed in (Zhang 2006b). The whole hardware system includes three major components a charge-coupled device (CCD) camera (Jai Pulnix TM-6740CL), a digital-light-processing (DLP) projector (PLUS U5-632h), and a frame grabber (Matrox Solios XCL-B). The projector has an image resolution of 1024×768 with a focal range of the projector is f=18.4 to 22.1 mm. The digital micro-minor device (DMD) chip used for this projector is 0.7 in. The CCD camera is a digital CCD camera with an image resolution of 640×480. The camera sensor size is 7.4 μm (H)×7.4 μm (V). It uses a Computar M1614-MP lens with a focal length of 16 mm at f/1.4 to f/16. The exposure time used for the camera is approximately 2.78 ms. The frame grabber is a single base, up to 85 MHZ, PCI-X frame grabber with 64 MB DDR SDRAM with CameraLink interface.

### 2.5. Experiment

We measure a complex object (Zeus bust) as shown in FIG. 5(a). This object has very complex geometric shape and various surface reflectivity, which is a good to verify the performance of the proposed algorithm. In this research, 5 binary patterns are used to obtain the codeword with P₀=768, and P₄=48. FIG. 5(b) shows the longest pitch image captured by the camera, and FIG. 5(c) shows the shortest pitch image. We then project three phase-shifted fringe images with a pitch number 24 and phase-shift of 2π/3.

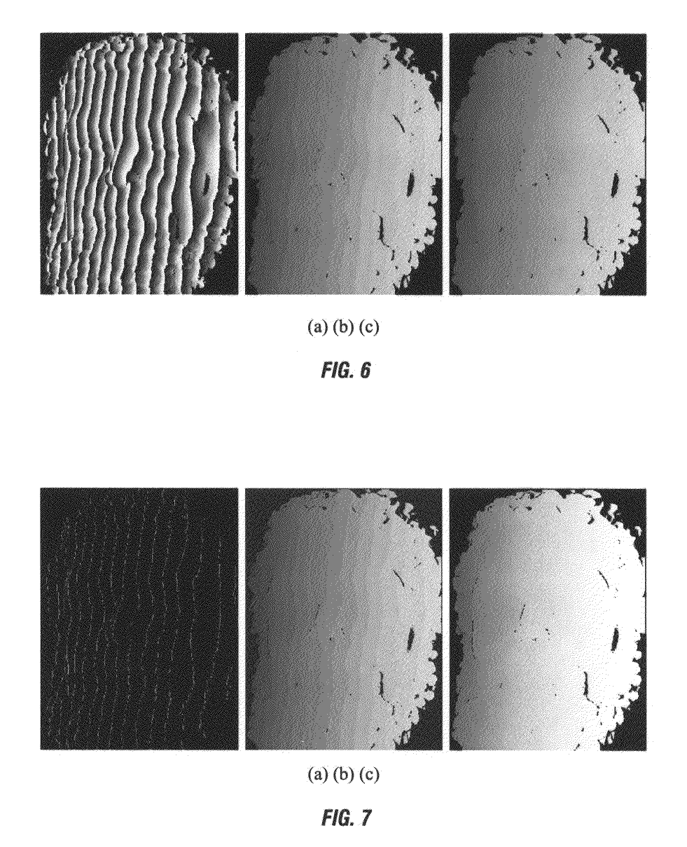

FIG. 6 shows the result using the acquired 8 images. FIG. 6(a) shows the wrapped phase map of the fringe images with a threshold of γ=0.1. The codeword generated from the captured image directly is shown in FIG. 6(b). Because of the problems related to the surface reflectivity variations of the object, the sampling of the camera, and the digitization of the projector, there are points that did not get correct codewords (random black and white points in this figure). If this codeword map is directly applied to correct the wrapped phase map, it will generate a phase map as shown in FIG. 6(c). For this unwrapped phase map, there are a number of problems: 1) the incorrect codewords will bring directly into the unwrapped phase map (black and white points); and 2) many points near the 2π jump points are not correctly unwrapped since the correct phase map should be smooth across the image. However, in this unwrapped phase map, there are a number of lines, which are not correctly unwrapped.

The incorrectly unwrapped points are mainly caused by two sources: 1) the incorrectly calculated codewords, and 2) the digitalization problem. Although the project projects the binary codeword changes are precisely aligned with the 2π jumps of the phase, the digitalization of the projected fringe images and the noise of the system. This digitalization may cause the 2π jumps shift backward or forward. This means that the alignments between the codeword changes and 2π jumps are not ensured after sampling. To solve this problem, the gradient of the phase map is calculated (as shown in FIG. 7(a)), which is used to adjust the codeword change locations. The essential idea is to determine where the codeword should change so that it can be applied to unwrap the phase. The criteria to relocate the codeword change points is to find the maximum phase gradient points of the 3 neighboring pixels horizontally (for vertical stripes). Once this codeword relocation process is applied, the incorrectly calculated codeword points are drastically reduced. The result is shown in FIG. 7(b). This codeword is then applied to the wrapped phase map to unwrap it, the result is significantly improved as shown in FIG. 7(c).

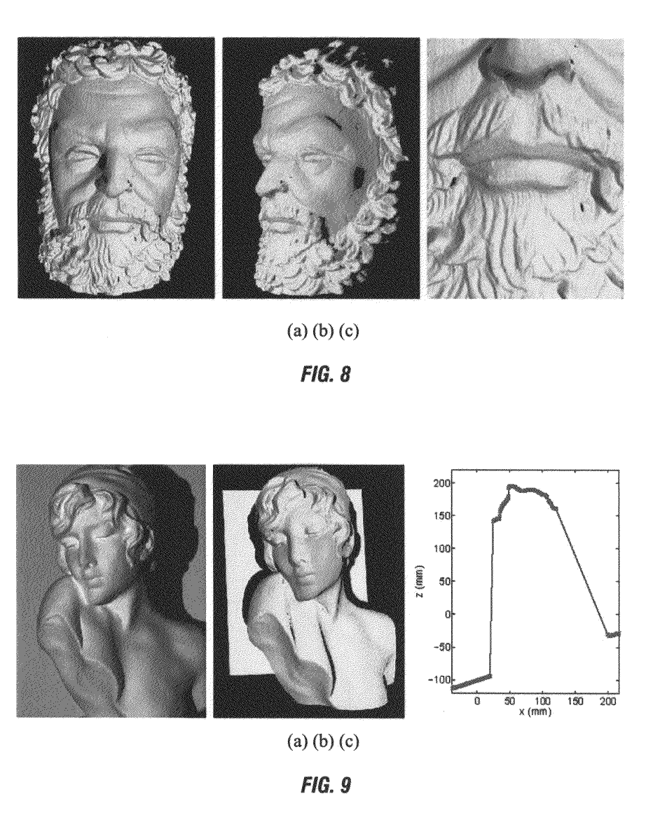

Once the unwrapped phase map is obtained, it can be converted to coordinates using the calibrated parameters of the whole system. The 3D measurement result is shown in FIG. 8. Where FIG. 8(a) shows the full 3D map of the object, FIG. 8(b) shows another view of the 3D object, and FIG. 8(c) shows the zoom-in view. This experiments demonstrated that the proposed hybrid method can be utilized to measure complex 3D shapes.

To verify that the proposed approach can be used for measuring multiple objects simultaneously, we measured a sculpture and a white board that is significantly separate in depth from the sculpture (as shown in FIG. 9(a)). The measurement result is shown in FIG. 9. Here FIG. 9(a) shows the photograph of the measured object, FIG. 9(b) shows the 3D shape rendered in 3D shaded mode, and FIG. 9(c) shows the cross section of 240^{th} row from the top. It can be see that the white board is place far away from the object, approximately 240 mm, but both shapes can still be correctly measured. This experiment successfully demonstrated that our proposed method can be used for simultaneous multiple objects measurement.

### 2.6. Conclusion

Therefore a hybrid method for 3D shape measurement has been disclosed. The method combines the binary coding method and phase-shifting method to complete the measurement, embraces the merit of a binary structured light method: robust to noise, and that of a phase-shifting method: high resolution. The binary patterns are used to obtain the codewords to point-by-point unwrap the phase calculated from the phase-shifted fringe patterns. This technique does not require conventional phase-unwrapping step, thus is suitable for measuring arbitrary step-height objects. Simulations and experiments demonstrated that this proposed algorithm could successfully perform the measurement with very high quality.

### 3. Flexible 3D Shape Measurement Using Projector Defocusing

According to another aspect of the present invention, a three-dimensional (3D) shape measurement technique using a defocused projector is disclosed. The ideal sinusoidal fringe patterns are generated by defocusing binary structured patterns, and the phase shift is realized by shifting the binary patterns spatially. Because this technique does not require calibration of the gamma of the projector, it is easy to implement and thus is promising for developing flexible 3D shape measurement systems using digital video projectors.

### 3.1. Introduction

3D shape measurement is very important to numerous disciplines as previously discussed. With recent advancements in digital display technology, 3D shape measurement based on digital sinusoidal fringe projection techniques is rapidly expanding. However, developing a system with an off-the-shelf projector for high-quality 3D shape measurement remains challenging. One of the major issues is nonlinear gamma effect of the projector.

To perform high quality 3D shape measurement using a digital fringe projection and phase-shifting method, the projector gamma calibration is usually mandatory. This is because the commercial video projector is usually a nonlinear device that is purposely designed to compensate for human vision. A variety of techniques have been studied including the methods to actively change the fringe to be projected (Huang et al. 2002, Kakunai et al. 1999) and those to passively compensate for the phase errors (Zhang et al. 2007a,b, Guo et al. 2004, Pan et al. 2009). Moreover, because the output light intensity does not change much when the input intensity is close to 0 or/and 255 (Huang et al. 2002), it is impossible to generate fringe images with fill intensity range (0-255). In addition, our experiments found that the projection nonlinear gamma actually changes over time, thus needs to be re-calibrated frequently. All these problems hinder its applications especially for precise measurement. In contrast, if a technique can generate ideal sinusoidal fringe images without worrying about nonlinear gamma, it would significantly simplify the 3D shape measurement system development.

This aspect of the present invention presents a flexible 3D shape measurement technique without requiring gamma calibration. The idea came from two observations: (1) seemingly sinusoidal fringe patterns often appear on the ground when the light shines through an open window blind; and (2) the sharp features of an object are blended together in a blurring image that was captured by an out-of-focus camera. The former gives the insight that an ideal sinusoidal fringe image could be produced from a binary structured pattern. And the latter provides the hint that if the projector is defocused, the binary structured pattern might become ideal sinusoidal. Because only binary patterns are needed, the nonlinear response of the projector would not be a problem because only 0 and 255 intensity values are used. Moreover, phase shifting can be introduced by spatially moving the binary structured patterns. Therefore, if this hypothesis is true, a flexible 3D shape measurement system based on a digital fringe projection technique can be developed without nonlinear gamma calibration. Experiments verify the performance of the proposed technique.

### 3.2. Principle

Sinusoidal phase-shifting methods are widely used in optical metrology because of its measurement accuracy (Malacara 2007). Here, we use a three-step phase-shifting algorithm with a phase shift of 2π/3, the intensities of these three fringe images are

I₁(x,y)=I′(x,y)+I″(x,y)cos(φ−2π/3), (3.1)

I₂(x,y)=I′(x,y)+I″(x,y)cos(φ), (3.2)

I₃(x,y)=I′(x,y)+I″(x,y)cos(φ+2π/3), (3.3)

Solving these three equations, the phase can be obtained

$$φ ( x , y ) = {tan}^{- 1} [ \frac{\sqrt{3} ( {I}_{1} - {I}_{3} )}{2 {I}_{2} - {I}_{1} - {I}_{3}} ] . \qquad ( 3.4 )$$

The equation provides the wrapped phase with 2π discontinuities. A spatial phase unwrapping algorithm can be applied to obtain continuous data (Zhang et al. 2007), which can be used to retrieve 3D coordinates (Zhang et al. 2006).

For a 3D shape measurement system using a sinusoidal phase-shifting algorithm, ideal sinusoidal fringe images are required. To generate ideal sinusoidal fringe images with a projector, one approach is to directly send the computer generated sinusoidal patterns to an in-focused projector and the other approach is to send the binary patterns to a defocused projector. The former has been proven successful with nonlinear gamma corrections. The latter does not have the problems related to nonlinear gamma, but is not trouble free. This because, intuitively, if the degree of defocusing is too small, the fringe stripes are not sinusoidal, while there are no high-contrast fringes if the projector is defocused too much.

Mathematically, a binary pattern generated by a computer can be regarded as a square wave horizontally, s(x), and the imaging system can be regarded as a point spread function (PSF), p(x). The defocusing of the projector will generate blurred images. The degree of blur can be modeled as different breadth of PSF. The PSF can be approximated as a Gaussian smoothing filter. If a filter is applied so that only the first harmonics is kept, ideal sinusoidal waveform will be produced. In Fourier domain, because the square wave only has odd harmonics without even ones, it is easier to design a filter to suppress the higher frequency components. Our simulation shows that by applying the Gaussian filter to a square wave, ideal sinusoidal waveform can indeed be generated, and the phase error will be less than 0.0003 rad if a three-step phase-shifting algorithm is applied.

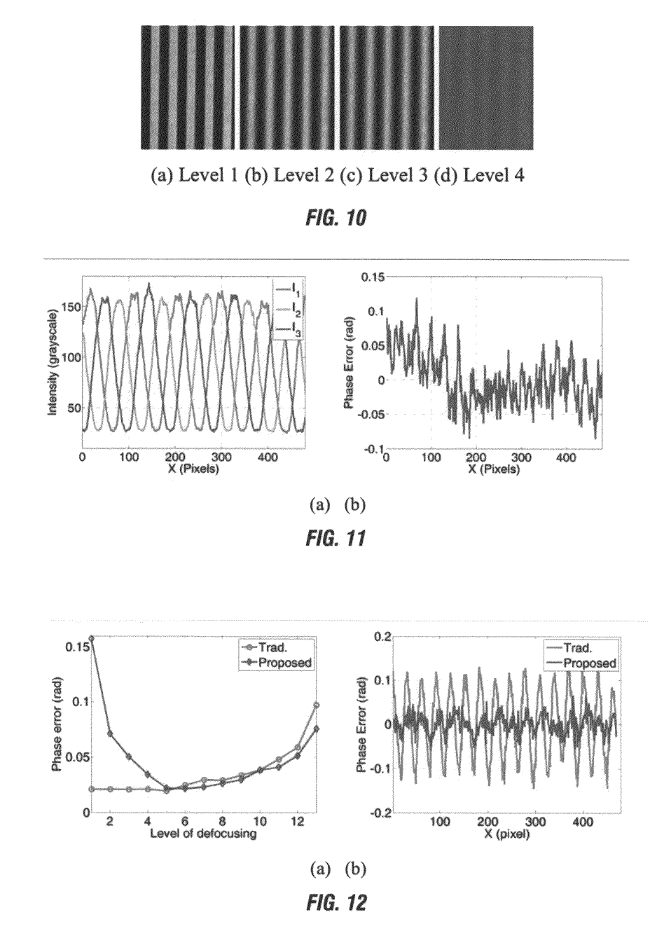

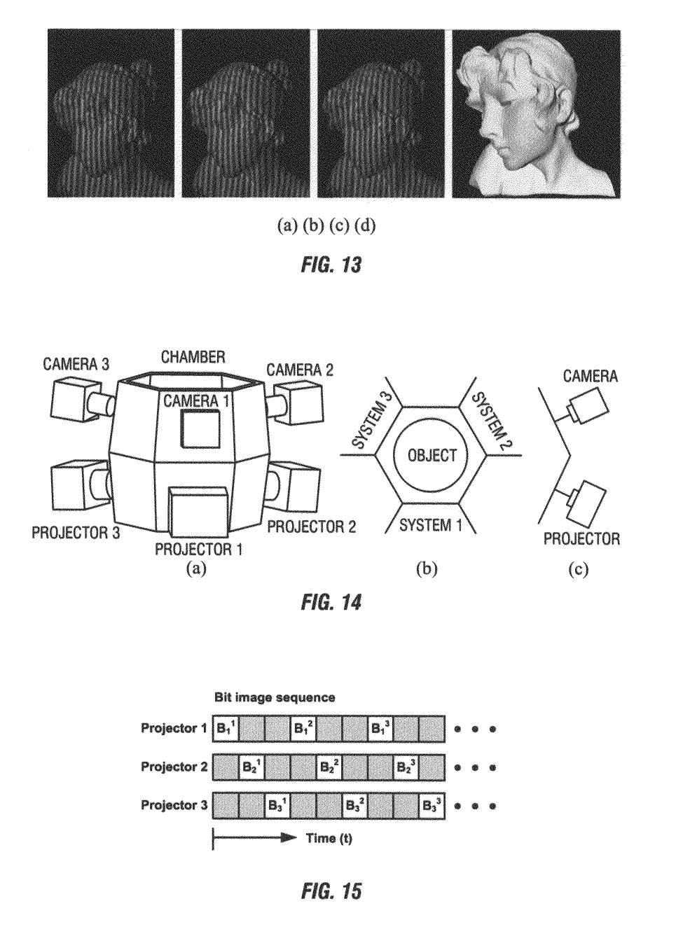

FIG. 10 shows examples of the fringe images captured when the projector is defocused at different levels. The degree of defocusing is controlled by manually adjusting the focal length of the projector. The image in FIG. 10(c) shows sinusoidal fringe stripes, thus it seems to be feasible to generate ideal sinusoidal patterns by properly defocusing binary patterns. However, if the projector is defocused too much, the contrast of the fringe images is low as shown in FIG. 10(d).

### 3.3. Experiments

The performance of the proposed approach was verified with a structured light system comprising of a Dell LED projector (M109S), and The Imaging Source digital USB CCD camera (DMK 21BU04) with a Computar M3514MP lens F/1.4 with f=35 mm. The camera resolution is 640×480, with a maximum frame rate of 60 frames/sec. The projector has a resolution of 858×600, and the projection lens with F/2.0 and f=16.67 mm.

A three-step phase-shifting algorithm is used for this experiment. By shifting the binary patterns ⅓ of the period, the phase-shifted fringe images with a phase shift of 2π/3 can be generated. Three spatially shifted fringe images under the defocusing level 3 (shown in FIG. 10(c)) are projected onto a uniform white flat board and are captured by the camera. FIG. 11(a) shows the 200^{th} cross sections of these fringe images. It shows the desired phase-shifted fringe images can be generated by shifting binary patterns spatially.

Applying Eq. (3.4) to these fringe images, the wrapped phase map can be obtained. The phase is then unwrapped by applying a spatial phase unwrapping algorithm (Zhang et al. 2007). FIG. 11(b) shows the 200 row cross section of the phase after removing the unwrapped phase slope. Because the nonsinusoidal waveforms usually result in periodical phase errors while no obvious periodical patterns appear in this phase map, ideal sinusoidal fringe images are actually generated. It should be noted that the camera is always in focus to capture surface details.

To compare the performance of the proposed approach against the traditional method, 13 levels of defocusing are tested. The projector starts with in focus and then increases its degree of defocusing. For the traditional method, the gamma of the projector is calibrated and the associated phase error is compensated. FIG. 12(a) shows the phase error. This experiment indicates that when the projector is in focus, the traditional method works better. When the projector is defocused to a degree, the proposed method starts outperforming the traditional one. It is interesting to know that both methods produce similar phase error under their own best conditions. Moreover, another experiment is also performed without nonlinear gamma correction, the phase map are shown in FIG. 12(b). This figure clearly shows that the traditional method is much worse than the proposed one without gamma correction.

A complex object is then measured with this proposed approach. FIG. 4 shows the measurement result. In order to measure a larger range, a Computar M1208-MP lens (F/1.4, f=8 mm) was used for the camera. In this research, the phase is converted to coordinates by applying a phase-to-height conversion algorithm (Zhang 2006) and the 3D geometry is smoothed by a 5×5 Gaussian filter to reduce the most significant random noises. This experiment shows that the proposed approach can be used for measuring 3D objects with complicated features.

### 3.4. Discussions

Comparing with a binary structured-light-based 3D shape measurement method, a phase-shifting based one has the advantage of spatial measurement resolution because it can reach pixel level with the minimum number of three fringe images. However, one drawback of phase-shifting based system lies in the complexity of generating ideal sinusoidal fringe patterns. Errors resulting from nonsinusoidal waveforms are significant if there is no gamma correction. On the contrast, the proposed method does not have this problem because only two intensity levels are used.

The advantage of the proposed approach is to avoid the error caused by nonlinear gamma of a digital video projector, while still maintains the advantage of a phase-shifting based approach. However, because almost all existing structured light system calibration methods require the projector to be in focus, none of them can be adopted to calibrate the proposed system since the projector is defocused. This research used a standard phase-to-height conversion algorithm using a reference plane (Zhang 2006), albeit it is not accurate for large depth range measurement. Another possible shortcoming of this approach is that the degree of defocusing must be controlled to a certain range in order to produce high-contrast fringe images. Even with these drawbacks, this technique is still very useful because it significantly simplifies the problem relating to the ideal fringe generations with a digital video projector.

### 3.5. Conclusions

Therefore, a flexible 3D shape measurement technique based on projector defocusing effect. Experiments have verified the feasibility of this new method. Because only two levels (0's and 255's) are used for sinusoidal fringe generation, there is no need to calibrate the projector's nonlinear response. Therefore, it simplified the development of 3D shape measurement system using a digital projector. Moreover, because generating binary fringe images are much easier than generating sinusoidal ones, this technique could potentially provide new views for 3D optical metrology.

### 4. Sinusoidal Fringe Pattern Generation: Defocusing Binary Patterns (DBP) Versus Focusing Sinusoidal Patterns (FSP)

A study was conducted which focuses on understanding how the degree of defocusing affects the phase error, and thereby the measurement error through simulations and experiments. For simulation, the defocusing effect is modeled as a Gaussian smoothing filter, different degrees of defocusing is treated as how many times the Gaussian filter is applied to the signal. A three-step phase-shifting algorithm was applied to compute the phase, and the phase error is then analyzed at different level of defocusing. The degree of defocusing is realized by adjusting the focal length of the projector while keeping the physical relationship between the projector and the object. Both simulation and experiment showed that the phase error caused by defocusing do not change significantly over a larger range.

Comparing with focusing a sinusoidal pattern approach (FSP), generating sinusoidal fringe patterns by defocusing a binary structured patterns has the following major advantages:
No precise synchronization between the projector and the camera is necessary. For the FSP method, where the in-focused projector projects computer generated sinusoidal fringe patterns, the camera and the projector must be precisely synchronized to capture high quality fringe images for 3D shape measurement. For this method, because the sinusoidal fringe patterns are generated by defocusing binary patterns, the synchronization plays a less important role for fringe image acquisition.
No gamma correction is required. The FSP method is very sensitive to the projector nonlinear gamma effect, thus the gamma calibration is needed. The proposed method is not sensitive to the projector gamma because only two grayscale levels are used.
No precise defocusing degree is needed. Different degrees of defocusing will vary the fringe images, but experiments found that within a large range of the defocusing, the phase errors are all very small. Therefore, a large range of defocusing can be used to perform high quality 3D shape measurement.

However, because the sinusoidal patterns are not generated directly by the computer, the degree of defocusing affects the measurement if the DBP method is used. On the contrast, the FSP method that uses an in-focused projector does not have this problem because the measuring objects are placed near its focal plane.

The study analyzed the phase errors caused by the following effects: (1) degree of defocusing, (2) exposure time, (3) synchronization, and (4) projector's nonlinear gamma. Both simulation and experiments showed that the degree of defocusing affect the phase error but within a large range of defocusing, the phase error is very small. Generating sinusoidal fringe images by defocusing the binary patterns are less sensitive to the exposure time used, the synchronization between the projector and the camera, and the projector's nonlinear gamma. On the contrast, for a conventional method where the sinusoidal fringe images are generated by the computer and projected by the in-focus projector, all these factors must be controlled well to ensure high-quality measurement.

### 5. 3D Dynamic Geometry and Fluorescent Images for Study of the Heart, Including Cardiac Arrhythmias

According to another aspect of the present invention, the present invention provides for a high-speed 3D geometry and fluorescent imaging technique that may be used in the field of cardiac bioelectricity for the advancement of our understanding of heart diseases and the development of better therapies. According to this aspect of the present invention a high resolution, high-speed 3D imaging technique may be used for mapping the dynamics of functional anatomy of the live heart.

In this aspect of the present invention, the 3D reconstruction algorithm is used to reach high resolution and panoramic measurement range and DLP projector is modified to achieve high speed. The methodology provides for the projector to be defocused as previously discussed in Section 3.

In order to provide panoramic 3D imaging, multiple projectors and multiple cameras may be used.

FIG. 14 shows the setup of the panoramic imaging system. Three camera-projector pairs are spread around the object with 120 degrees apart. Each system acquires one piece of the object and synchronized with each other. The individual system is calibrated using the calibration method. Thus each pair will generate 3D measurement points in its own coordinate systems. To merge all pieces together, three systems have to be calibrated again to find the transformation matrix between their own coordinate systems. One way to calibrate the system would be by measuring a standard cylinder with marker points on it. The markers are used to establish the correspondences between systems, based on which transformation between systems can be determined.

Even though the calibration results in very good result, the alignment is usually not very precise due to the measurement errors or noise. Therefore, the alignment refinement is required. One way to provide alignment would be to adopt the iterative-closest-points (ICP) algorithm to align the geometries frame to frame (Besl & McKay 1992, Chen & Medioni 1992, Zhang 1994). Once the coordinates are transformed into the same world coordinate system, they can be merged using the technique of Holoimage (Gu et al. 2006). We have demonstrated that the high-quality merging is feasible by using the Holoimage technique (Zhang & Yau 2008).

All projectors use white light source, the interference will influence the measurement drastically. To avoid this problem, three projectors are projecting structured patterns alternatively, and cameras are synchronized with their own corresponding projector to capture the structured patterns. FIG. 15 illustrates the principles. For a sequence of 24 bit images, each bit image represents one binary pattern that is used for 3D reconstruction. For any instance, only one projector projects effective structured patterns, while the other two project black (no light output) images. By generating the pattern-black-black, black-pattern-black, and black-black-pattern sequences, the light interference problem will be resolved. Because the projector can project bit images at a frame rate of 4800 Hz, and only 21 bits are used to capture a panoramic 3D frame, the 3D data acquisition speed can reach as fast as 228 Hz.

It is contemplated that signal-to-noise ration (SNR) may be a potential problem. Since the projection speed is so fast, the duration for each bit is very short (approximately 0.2 millisecond), the camera image may not have enough signal. The possible solution is to combine two or three bits to produce one structured patterns. The drawback of this approach is that the speed will be reduced. If the measurement speed of 228 Hz is found not sufficient for the beating heart, the panoramic system can be easily adapted to increase the measurement speed drastically by putting filters in front of the camera, so that each camera-projector pair only works with a certain range of spectrum of light without overlapping.

The scanners may shift during the capture process. In this case, it would be helpful to correct the calibration each time before performing the measurement. However, the intrinsic parameters of the system that describe the lens and the sensors properties should not change over time, thus, need not to be re-calibrated. The only possible change is physical transformation between different systems, which can be calibrated before the measurement every time. The simplest way to calibrate the transformation is measure a standard object, such as a sphere or a cube, using three systems simultaneously, by making the output data to be the ideal surface, the transformation matrices are estimated.

It is contemplated if the measurement speed is sufficiently high (such as over 200 Hz), the geometric motion of the beating heart can be accurately measured. For a heart imaging system, the object may be put into a hexagonal chamber. The camera and the projector are perpendicular to the surface of the chamber to alleviate the problems related to the refractive and reflective light induced by the chamber. Three systems are expected to be sufficient to capture the panoramic 3D geometry of the heart because the heart shape is regular. Also, for the initial test, the heart is may be immersed into liquid, and this design will also reduce the problems caused by liquid refraction.

It is further contemplated that various key factors may affect the measurement quality for the heart. These include:
(a) Calibration accuracy. The calibration is the first key issue to improving the measurement accuracy. Because the system is a miniaturized 3D system, the manufacturing of the standard checkerboard target for calibration will be challenging. We found that the size of the checker squares will affect the calibration accuracy (William et al. 2009). The optimal calibration checker squares may be determined and evaluated for this system.
(b) Surface shine. The heart surface is partially shiny. Because the phase-shifting algorithm is used, it is very sensitive to pick up any signal, thus the influence is alleviated because lower exposure can be used. However, it is very difficult to completely avoid the problem induced by the shiny areas. We will evaluate how much it will affect the measurement. For the small areas that no information is obtained, the 3D geometries will be predicted based on the surrounding geometries since the heart surface is pretty regular and smooth.
(c) Camera resolution. Camera resolution will affect the spatial resolution of the measurement. Experiments will be performed to determine the minimum resolution to be used. We expect that the 100×100 resolution is sufficient to measure a rabbit heart.
(d) Measurement speed. We will determine the minimum speed to accurately measure the beating heart. If the speed is not fast enough, some very obvious artifacts will appear (similar to the blur effect of a 2D imaging system). We anticipate that 200 Hz data acquisition is sufficient to measure the beating rabbit heart.

It is contemplated that the resulting 3D shape measurement system will achieve very high speed (>200 Hz), with high spatial resolution (<0.2 mm), and high depth accuracy (<0.05 mm).

One challenge in adapting a structured light system to measure a rabbit heart is the surface property of the heart. The heart surface is partially specular. Specular reflections are problematic because they overload the CCD receptor so that the true gray level is unknown. There are three possible solutions for this that we will explore. The first is to use a priori knowledge of the approximate shape to determine where to decrease the overall intensity of the fringe image so that the specularly reflected light intensity is reduced. The second solution is to employ an additional camera capturing from a different viewing angle simultaneously (Hu et al. 2005). The saturated areas in one camera will be filled in by the secondary camera. The third solution is to use a polarizing filter positioned in front of the projector and the camera (Yoshinori et al. 2003). This technique has been widely used in optical metrology field. The only drawback of using this technique is that the light intensity will be reduced drastically.

The divergent lights of the projector and the camera may cause a problem of measuring the heart due to the chamber surface and the fluid inside the chamber. The alternative solution is use additional lenses to collimate the light onto the surface of the chamber so that the incoming light is perpendicular to the chamber.

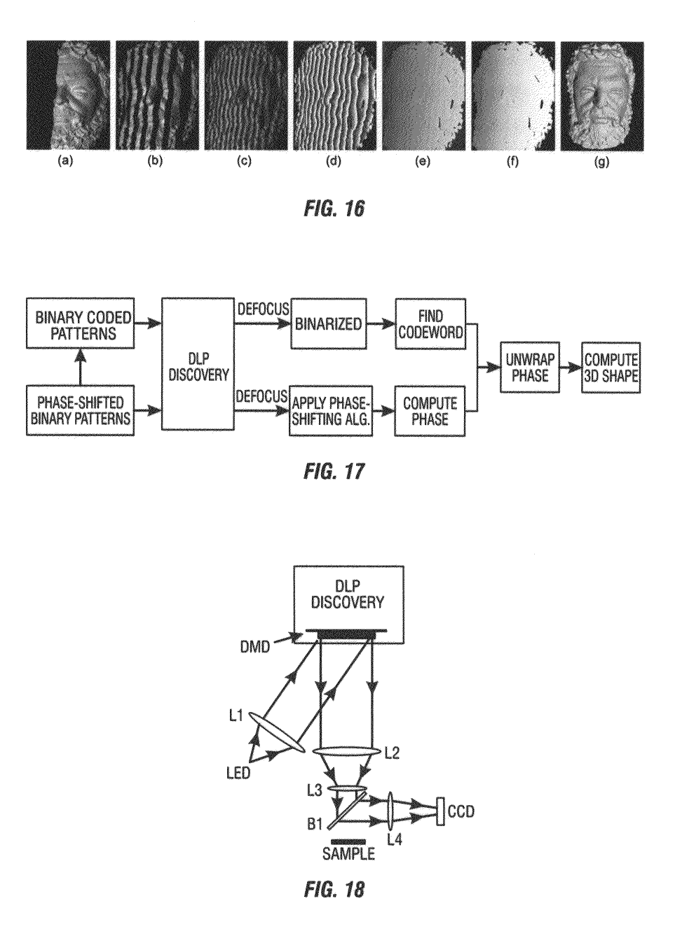

Panoramic 3D imaging of the heart. A single, static 3D texture-mapped geometric model of an immobilized rabbit heart (Qu et al. 2007) may be constructed. This model may be used to combine three optical images into a single data set. The construction process (FIG. 16) is as follows: 1) A calibration pattern, in the form of a cube with a checkerboard pattern, is placed on the rod used to suspend the heart. 2) A CCD camera is pointed at the heart and the heart is rotated to capture 20-60 images. 3) Camera calibration (Zhang 2000) is used to determine the camera position relative to the heart for each image. 4) The heart silhouette is automatically extracted from each image. 5) Volume carving (Kay et al. 2004) is used to produce points on the surface. 6) A smooth surface model (Grimm 2005) is fit to the data points. 7) The original images are projected back onto the surface to create a texture map. This procedure is clearly very slow, and relies on accurate extraction of the calibration pattern and silhouettes from the input images.

### 6. Three-Dimensional Sensing System

FIG. 17 illustrates one embodiment of a pipeline of a 3D sensing system. For a structured light-based 3D surface sensing method, sensing temporal resolution is ultimately determined by the structured pattern switching speed. Therefore, to increase the temporal resolution, a faster image-switching system is desired. Recently, Digital Light Innovation Inc. introduced the DLP Discovery D4000 to address the special needs of high-speed light modulation. Because it can switch 1-bit images at tens of kHz, this device could allow for a kHz rate by using binary structured patterns. But a binary-pattern based method is not desirable for high spatial resolution 3D surface sensing because it cannot achieve pixel level resolution. A digital fringe projection and phase-shifting method can meet this need. However, the conventional phase-shifting algorithm cannot be directly implement into such a device because only 1-bit images can be switched at its fast image switching mode while at least 8-bit images are needed in the sinusoidal fringe images used in a conventional phase-shifting algorithm.

To address such a problem, the ideal sinusoidal fringe images may be generated by blurring images. This blurring effect often occurs when a camera captures an image out of focus, and all sharp features of the object all be blended together. In optics, the blurring effect can be realized by defocusing, or positioning the screen out of focal plane. However, this technique is not trouble free. To generate sinusoidal fringe images for a different stripe width, different degrees of defocusing have to be used. It would be highly impractical to vary the focal length of a lens at tens of kHz. The 3D recovery algorithm previously discussed may be used because it only requires the narrowest fringes to be sinusoidal, and thus the degree of defocusing can be fixed.

As shown in FIG. 17, a sequence of binary-coded structured patterns and spatially phase-shifted binary patterns are sent to a DLP Discovery projector. The DLP projector switches and projects the binary patterns sequentially and automatically. The lens of the projection system is defocused on purpose so that the binary patterns will be blurred to a degree that the phase-shifted binary patterns become sinusoidal ones. The phase-shifting algorithm is applied to the phase-shifted fringe patterns for phase computation, and the remaining blurred structured patterns are binarized for codeword determination. The hybrid algorithm previously discussed may be used to obtain an unwrapped phase map, which is converted to 3D coordinates. Thus, temporal resolution may be significantly increased (from tens of Hz to kHz rates) and spatial resolution (from mm to um) and allowing for multiple-object sensing.

To achieve microscale spatial resolution, the system should be focused on small surfaces. FIG. 18 schematically shows one embodiment of a system layout. The light emitting from an LED light source is collimated by lens L1 on the surface of a digital micromirror device (DMD), where the images will be formed. The reflected light from the DMD will first be focused by lens L2 and collimated by lens L3 to a smaller surface area. The light then passes through a beam splitter (B1) onto a sample surface. The sample surface is placed at an out-of-focal plane of the projection lens L2-L3 to ensure that the phase-shifted binary patterns will be blurred as sinusoidal ones. The camera captures images reflected from the sample through imaging lens L4. The structured patterns generated by the computer are loaded to the DLP Discovery board, which automatically switches the 1-bit images at tens of kHz. The camera should be precisely synchronized with the projection of each individual pattern to accurately capture fringe patterns for 3D recovery.

### 7. Ultrafast 3-D Shape Measurement with an Off-the-shelf DLP Projector

The present invention allow for unprecedented 3-D shape measurement speed with an off-the shelf DLP projector. The present invention allows for 3-D shape measurement speed beyond the digital-light-processing (DLP) projector's projection speed. In particular, a “solid-state” binary structured pattern is generated with each micro-minor pixel always being at one status (ON or OFF). By this means, any time segment of projection can represent the whole signal, thus the exposure time can be shorter than the projection time. A sinusoidal fringe pattern is generated by properly defocusing a binary one, and the Fourier fringe analysis means is used for 3-D shape recovery. We have successfully reached 4,000 Hz rate (80 microsecond exposure time) 3-D shape measurement speed with an off-the-shelf DLP projector.

### 7.1 Introduction

With recent advances in computational technology and shape analysis, high-speed 3-D shape measurement has become unprecedentedly important. Over the years, a number of techniques have been developed. Among these techniques, fringe analysis stands out because of its numerous advantages (Gorthi et al. 2010). A Fourier method reaches the fastest 3-D shape measurement rate because it only requires a single fringe pattern (Takeda et al. 1983). Conventionally, the fringe patterns are either generated by a mechanical grating or by a laser interference. These techniques have been widely applied to measuring numerous extreme phenomena (Takeda et al. 2010). However, it is typically not very flexible for them to adjust the fringe pitch (period) at a desired value.

Digital fringe projection techniques, recently emerged as a mainstream, have the advantage of generating and controlling the fringe pitch accurately and easily. In such a system, a digital video projector is used to project the computer generated sinusoidal fringe patterns onto the object, and the camera is used to capture the fringe patterns scattered by the object, 3-D information can then obtained from the phase map once the system is calibrated.

Over the years, a number of fringe projection techniques have been developed including some high-speed ones (Huang et al. 2003; Wang et al. 2009; Zhang et al. 2006). As previously noted, because of its digital fringe generation nature, the 3-D shape measurement speed is ultimately determined by the fringe projection rate: typically 120 Hz for a digital-light-processing (DLP) projector. For high-speed applications, using the minimum exposure time is always desirable. However, because the DLP projector generates the grayscale fringe images by time modulation (Hornbeck 1997). This means that if a grayscale image is used, the camera must be precisely synchronized with the projector in order to correctly capture the projected image channel by channel. In other words, the camera must start its exposure when the projector starts channel projection, and must stop its exposure when the projector stops projecting that channel. A conventional digital fringe projection technique, unfortunately, uses all grayscale values, thus the synchronization must be very precise to achieve 120 Hz 3-D shape measurement rate. Here, we will experimentally demonstrate that needs for precise synchronization if a conventional sinusoidal fringe pattern is used.

Because of the aforementioned fringe image generation mechanism of the DLP projector, the camera exposure time cannot be shorter than the single channel projection time ( 1/360 sec) for a 120 Hz projector. This limits its application to measure very fast motion (e.g., vibration, rotating fan blade, etc) when a very short exposure time is required. Our experiments demonstrated that in order to capture the blade of a rotating fan at 1793 rotations per second (rps), tens of ms exposure time is required. Therefore, it is impossible for a conventional fringe projection system to achieve the 3-D shape measurement speed faster than the DLP projector's projection speed (typically 120 Hz), and is impossible for them to use exposure time shorter each individual channel projection time (typically 1/360 sec).

To capture very fast motions, a solid-state fringe pattern is usually desirable and a Fourier method (Takeda et al. 1983) is usually necessary. The solid-state fringe pattern can be generated by a mechanical grating, or by a laser interference. However, as addressed earlier, it is very difficult for a digital fringe projection technology to produce solid-state fringe pattern, because it typically refreshes at 120 Hz. On the other hand, because of its inherently digital fringe generation nature, the digital fringe generation technique has some advantageous features including the flexibility to generate fringe patterns.

Because the projector is inherently a digital device, using binary structured patterns for 3-D shape measurement is advantageous. This leads to the exploration of utilizing binary structured patterns to generate sinusoidal ones to potentially overcome the speed bottleneck. Structured light technologies based on binary structured patterns have been extensively studied and well established (Salvi et al. 2010). Typically, for such a system, multiple structured patterns are needed to achieve high spatial resolution. To reach real-time, the structured patterns must be switched rapidly and captured within a short period of time. Rusinwiski et al. (2002) developed a real-time 3-D model acquisition system based on stripe boundary code (Hall-Holt et al. 2001). Davis et al. has developed a realtime 3-D shape measurement system based on Spacetime stereo vision method (Davis et al. 2005). Recently, Narasimhan et al. (2008) developed a temporal dithering technique for 3-D shape measurement. However, unlike an aforementioned sinusoidal fringe analysis technique, it is difficult for any of binary structured pattern based methods to reach pixel-level spatial resolution because the stripe width must be larger than one projector pixel (Zhang, 2010). In addition, because it is required to switch structured patterns, the speed is even lower than the projector's projection speed.

This research is to combine the binary structured light method with sinusoidal fringe analysis technique to achieve both high spatial and high temporal resolution. It is to enable digital fringe projection technique to generate “solid-state” by employing our recently developed flexible 3-D shape measurement technology through defocusing (Lei et al. 2009). For this technique, instead of using 8-bit grayscale fringe images, the binary gray level (0s or 255s) is used. This coincides with the fundamental image generation mechanism of the DLP technology that operates the digital micro mirrors in binary status (ON of OFF). Therefore, theoretically, if a micro mirror is set to be a value of 0 or 255, it should stays OFF or ON all the time. By this means, the micro mirror will act as solid-state (does not change), thus the solid-state light should be generated. These binary structured patterns can be converted to seemingly sinusoidal ones if the projector is properly defocused (Lei et al. 2009). Therefore, by this means, this technique has both advantages of the fringe analysis based technique (high spatial resolution) and the binary structured pattern technique (high temporal resolution).

To verify the performance of the proposed technology, an inexpensive off-the-shelf DLP projector (less than $400) is used to generate the sinusoidal fringe patterns, and a high-speed CMOS camera is used to capture the fringe images reflected by the object. Our prototype system has successfully reached 4,000 Hz rate (80 ms exposure time) 3-D shape measurement speed with an off-the-shelf DLP projector. In contrast, if a conventional fringe generation technique is used, once the capturing rate goes beyond 360 Hz, the waveform of the capture fringe pattern becomes nonsinusoidal in shape, and measurement error will be significantly increased. Because the fringe pattern is generated digitally, this proposed technique provides an alternative flexible approach for high-speed 3-D shape measurement that is traditionally utilizes a mechanical grating, or a laser interference.

Section 7.2 introduces the principle of the proposed technique. Section 7.3 shows some experimental results. Section 7.4 discusses the advantages and limitations of the proposed technology, and Sec. 7.5 summarizes.

### 7.2. Principle

### 7.2.1. Revisit of Digital-Light-Processing (DLP) Technology

Digital light processing (DLP™) concept originated from Texas Instruments in the later 1980's. In 1996, Texas Instruments began its commercialized DLP™ technology. At the core of every DLP™ projection system there is an optical semiconductor called the digital micro-mirror device, or DMD, which functions as an extremely precise light switch. The DMD chip contains an array of hinged, microscopic mirrors, each of which corresponds to one pixel of light in a projected image.

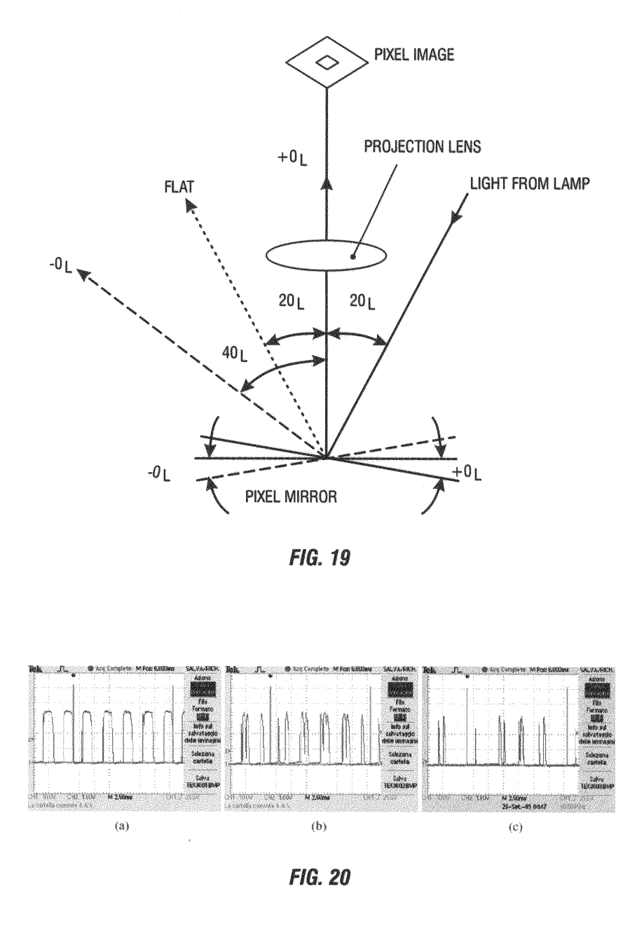

FIG. 19 shows the working principle of the micro mirror. Data in the cell controls electrostatic forces that can move the mirror +θ_{L} (ON) or −θ_{L} (OFF), thereby modulating light that is incident on the mirror. The rate of a mirror switching ON and OFF determines the brightness of the projected image pixel. An image is created by light reflected from the ON mirrors passing through a projection lens onto a screen. Grayscale values are created by controlling the proportion of ON and OFF times of the mirror during one frame period—black being 0% ON time and white being 100% ON time.

DLP™ projectors embraced the DMD technology to generate the color images. All DLP™ include light source, a color filter system, at least one digital micro-mirror device (DMD), digital light processing electronics, and an optical projection lens. For a single-chip DLP projector, the color image is produced by placing a color wheel into the system. The color wheel, that contains red, green, and blue filters, spins at a very fast speed, thus red, green and blue channel images will be projected sequentially onto the screen. However, because the refreshing rate is so high, human eyes can only perceive like a color image instead of three sequential ones.

A DLP projector produces a grayscale value by time integration (Hornbeck, 1997). A simple test was performed for a very inexpensive DLP projector, Dell M109S. The output light was sensed by a photodiode (Thorlabs FDS100), and photocurrent is converted to voltage signal and monitored by an oscilloscope. The projector has an image resolution of 858×600, and 10,000 hours of life time. The brightness of the projector is 50 ANSI Lumens. The projection lens is a F/2.0, f=16.67 mm fixed focal length one. The projection distance is approximately 559-2,000 mm. The DMD used in this projector is 0.45-inch Type-Y chip. The photodiode used has a response time of 10 ns, an active area of 3.6 mm×3.6 mm, and a bandwidth of 35 MHz. The oscilloscope used to monitor the signal is Tektronix TDS2024B, the oscilloscope has a bandwidth of 200 MHz.

FIG. 20 shows some typical results when it was fed with uniform images with different grayscale values. The projector synchronizes with the computer's video signal through VSync. If the pure green, RGB=(0, 255, 0), is supplied, there are five periods of signal output for each VSync period, and the signal has the duty cycle of almost 100% ON. When the grayscale value is reduced to 128, approximately half of the channel is filled. If the input grayscale value is reduced to 64, a smaller portion of the channel is filled. These experiments show that if the supplied grayscale value is somewhere between 0 and 255, the output signal becomes irregular. Therefore, if a sinusoidal fringe pattern varying from 0 to 255 is supplied, the whole projection period must be captured to correctly capture the image projected from the projector. This is certainly not desirable for high-speed 3-D shape measurement where the exposure time must be very short.

### 7.2.2. Principle of Generating Fringe Pattern by Defocusing

In the previous section, we have discussed that if the micro mirror of the DLP projector is fed with 0 or 255, it will remain the state of OFF or ON 100% of time. Therefore, if only 0 or 255 is used for each pixel, the projected light will be solid-state. This provides the insight that it might be feasible to generate solid-state fringe patterns by the DLP technology. However, it also indicates that only 0s or 255s can be used in order to do so. This means that it is impossible to generate 255 gray level sinusoidal fringe patterns in a conventional fashion.

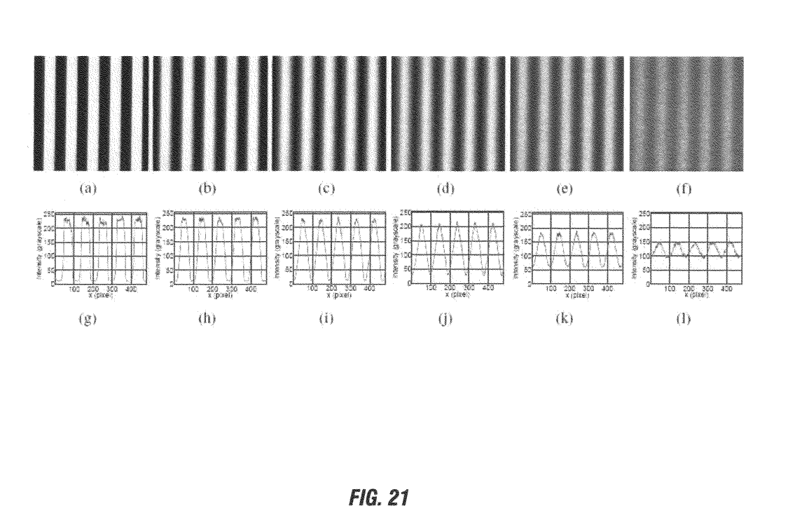

Defocusing has been used to get rid of pixel effects for a long time, but using it to make smooth irradiance profiles is new. It also has been used to 3-D shape measurement using Ronchi grating (Su et al. 1992). Our recent study showed that by properly defocusing a binary structured pattern, an approximately sinusoidal one can be generated (Lei et al. 2009). FIG. 21 shows some typical results when the projector is defocused to different degrees while the camera is in focus. It shows that if the projector has a different defocusing level, the binary structured pattern is distorted to different degree. FIG. 21, panel (a) shows the result when the projector is in focus: clear binary structures on the image. With the degree of defocusing increasing, the binary structures become less and less clear, and the sinusoidal ones become more and more obvious. However, if the projector is defocused too much, sinusoidal structures start diminishing, as indicated in FIG. 21, panel (f). FIG. 21, panels (g)-(l) illustrate cross sections of the associated fringe patterns. This experiment indicates that a seemingly sinusoidal fringe pattern can indeed be generated by properly defocusing a binary structured pattern.

### 7.2.3. Fourier Method for 3-D Shape Measurement

Fourier method for 3-D shape measurement was proposed by Takeda and Mutoh (1983), and has been widely applied to many applications (Su et al. 2010). This technique has the advantage of 3-D shape measurement speed because only one single fringe image is required. Essentially, it takes one single fringe images to perform Fourier transform, a band-pass filter is applied to keep the carrier frequency component, and finally the phase is obtained by applying an inverse Fourier transform for phase calculations. Typically, a fringe pattern can be mathematically represented as

I=a(x,y)+b(x,y)cos(φ(x,y)),

where a(x,y) is the DC component or average intensity, b(x,y) the intensity modulation or the amplitude of the carrier fringes, and φ(x, y) the phase to be solved for.
The above equation can be rewritten in complex form as

$$I = a ( x , y ) + \frac{b ( x , y )}{2} [ {e}^{j φ ( x , y )} + {e}^{- j φ ( x , y )} ] .$$

If a bandpass filter is applied in the Fourier domain so that only one of the complex frequency component is preserved, we will have

$${I}_{f} ( x , y ) = \frac{b ( x , y )}{2} {e}^{j φ ( x , y )} .$$

Then the phase can be calculated by

$$φ ( x , y ) = arctan \{ \frac{Im [ {I}_{f} ( x , y ) ]}{Re [ {I}_{f} ( x , y ) ]} \} ,$$

here Im(X) is to take the imaginary part of the complex number X, and Re(X) to get the real part of the complex value X. This equation provides phase values ranging from −π to π. The continuous phase map can be obtained by applying a phase unwrapping algorithm (Ghiglia et al. 1998). 3-D coordinates can be calculated once the system is calibrated (Zhang et al. 2006). However, in practice, because the projector is defocused, a conventional projector calibration technique does not apply. Therefore, the whole system calibration is very challenging.

In this research, we use a conventional approximation approach to calibrate the system (as described in Zhang et al. (2002)). This technique is essentially to measure a known step height object relative to a flat reference plane, and calibrate the linear coefficient (K_{z}) between the phase changes and the true height of the step. The x and y are also linearly scaled (Kₓ, K_{y}) to match the real dimension. All the measurement is performed relative to the reference plane.

### 7.3 Experiments

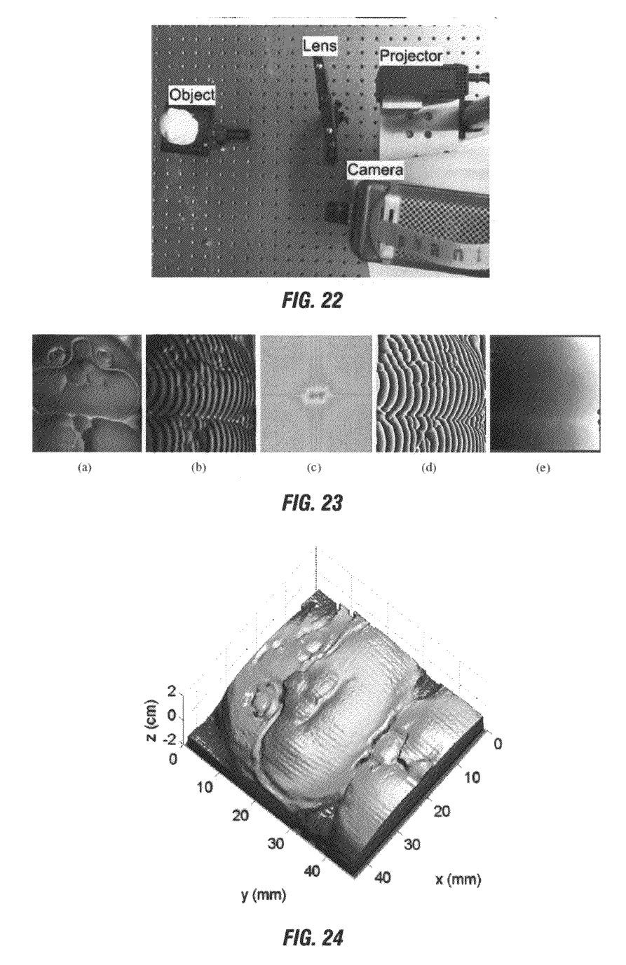

To verify the performance of the proposed algorithm, we developed a 3-D shape measurement system as shown in FIG. 22. We used the same LED projector, Dell M109S whose cost is less than $400, and is very compact. The camera used in this system is a high-speed CMOS camera, Phantom V9.1 (Vision Research, NJ), it can capture 2-D images at 2,000 Hz rate with a image resolution of 480×480. The exposure time used for all experiments is 250 microseconds. Because the brightness of the projector is not enough if the camera has a very short exposure time, a converging lens is placed in front of the projector is focus the projected image onto an area of approximately 67 mm×50 mm.

We first measured a static object using the system described above. FIG. 23 shows the measurement result. FIG. 23, panel (a), shows the photograph of the sculpture to be measured. FIG. 23, panel (b), shows the captured fringe image that shows seemingly sinusoidal patterns. A 2-D Fourier transform is then applied the fringe image that will result in the map in frequency domain as shown in FIG. 23, panel (c). Once a proper band-pass filter is applied, the wrapped phase can be obtained. FIG. 23, panel (d) shows the wrapped phase map. A phase unwrapping algorithm (Zhang et al., 2007) is then applied to unwrapped the phase obtained continuous phase map as shown in panel (e) of FIG. 23. The unwrapped phase map can be converted to 3-D coordinates using a phase-to-height conversion algorithm (Zhang et al. 2002). FIG. 24 shows the 3-D plot of the measurement. The result looks good, however, some residual stripe errors remains. This might be because the defocusing technique cannot generate ideal sinusoidal fringe patterns, and a phase error compensation algorithm needs to be developed to reduce this type of errors.

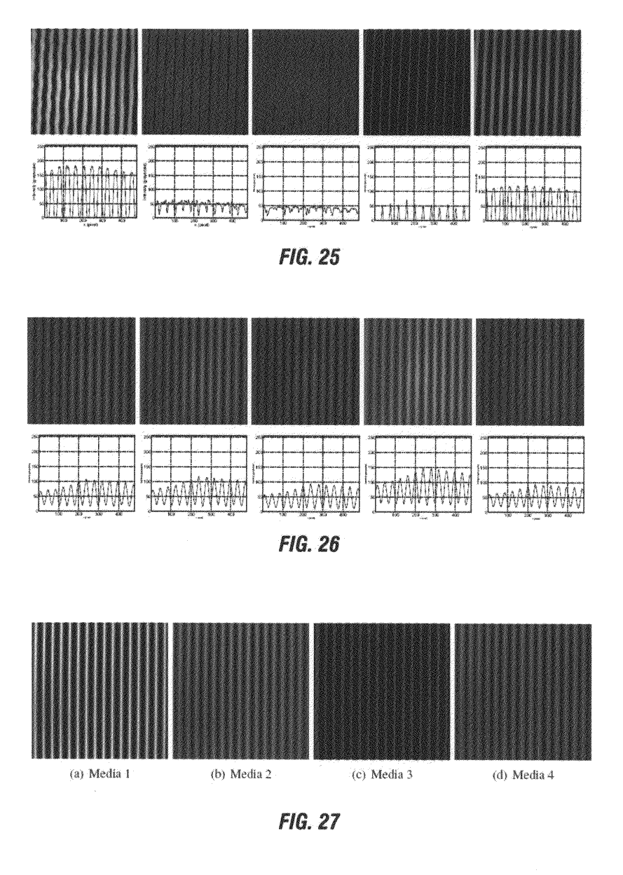

As a comparison, we used the same system set up and a conventional sinusoidal fringe generation method to capture the fringe images at 2,000 Hz rate and 250 microsecond exposure time. The image resolution for this experiment is again 480×480. FIG. 25 shows some typical recorded fringe images that do not appear to be sinusoidal in shape. From this experiment, we can see that even if the exposure time is 250 microsecond and the capture speed is 2,000 Hz, the sinusoidal fringe patterns cannot be well captured. Therefore, high-quality 3-D shape measurement cannot be performed from them.

On contrast, we used exactly the same system settings to capture the fringe patterns with defocusing technique: 2,000 Hz sampling rate with 250 microsecond exposure time. FIG. 26 shows some typical fringe images. As can be seen from this experiment, when the exposure time is short, the fringe patterns are still sinusoidal even though the intensity varies from frame to frame. The intensity variation was caused by the following three factors: (1) the projector projects red, green, and blue light in different timing; (2) red, green, and blue color may not be balanced because they came from different LED; and (3) the camera has different sensitivity to different light of color.

To further compare with the traditional sinusoidal fringe projection technique and the propose technique, we used two different exposure time, 1/60 sec, and 1/4,000 sec. FIG. 27 shows four images for the sinusoidal and the binary methods with these exposure time. The associated four videos shows show that if the camera is precisely synchronized to the projector and the exposure time is one projection cycle, the both methods can result in high-quality fringe patterns without large problems. On the contrast, if the exposure time is much shorter than the channel projection time, the captured fringe images generated by the binary method only vary intensity while keep its sinusoidal structure, whilst the capture fringe images generated by the conventional method vary both intensity and sinusoidal structure from time to time. It should be noted that in this experiment, we do not correct the nonlinear gamma of the projector, even the exposure time is right, the fringe pattern does not appear ideally sinusoidal. On the contrary, the binary one is not affected by the nonlinear gamma because only two intensity values are used. This is another advantage of the new method.

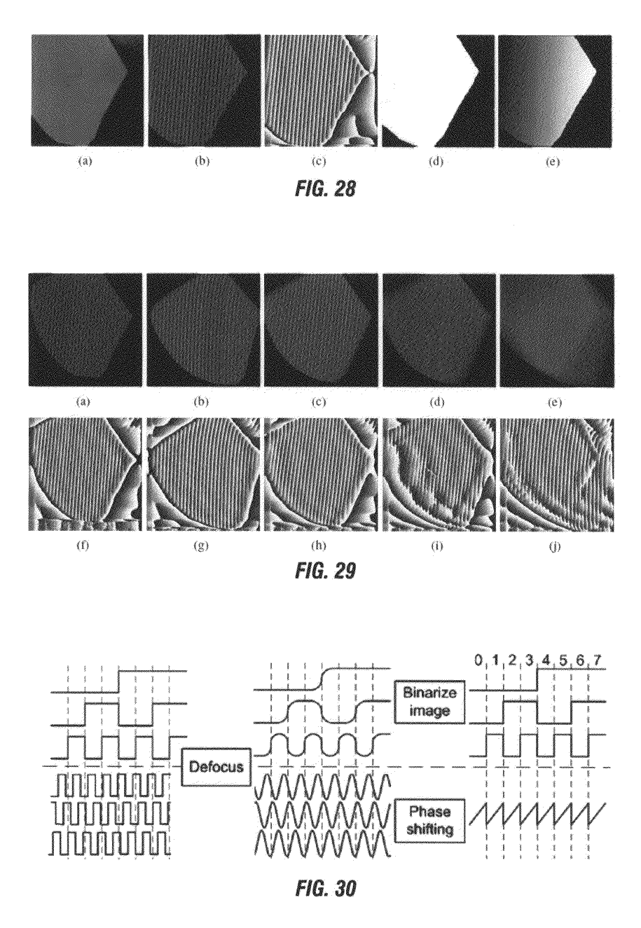

To test how fast the system can reach, we set the camera capture speed to be 4,000 Hz, exposure time to be 80 microseconds, and image resolution to be 480×480. Due to the projector output light intensity limitation, 80 microsecond the shortest exposure time we can use for our system to capture bright enough fringe patterns. A rotating fan blade was measured to verify the performance of the system. For this experiment, the fan is rotating at 1,793 rotations per minutes (rpm). FIG. 28 shows the experimental result. Panel (a) of FIG. 28 shows the photograph of the fan blade. Panel (b) of FIG. 28 shows the fringe pattern. It clearly shows the high-quality fringes. Fourier method is then applied to find the frequency spectrum of the fringe pattern, a band-pass filter is used to get one carrier frequency component, and the phase can be extracted. Panel (c) of FIG. 28 shows the wrapped phase map. From the fringe data, the DC component (I0(x;y)) can also be extracted to generate the mask (panel (d) of FIG. 28). After removing the background, the phase can be unwrapped, as shown in panel (e) of FIG. 28. Both the wrapped phase map and the unwrapped phase map show that the motion is well captured.

Using a very short exposure time is very essential in order to capture fast motion, such as the rotating fan blade as shown in the previous example. To demonstrate this, more experiments were performed, where the camera captures the image at 200 Hz with varying exposure time. FIG. 29 shows some of the fringe images and the associated wrapped phase map when the exposure time was chosen as 80, 160, 320, 640, 2,778 microseconds, respectively. Again, the image resolution is 480×480 for these experiments, and the fan is rotating at a constant speed of 1,793 rpm during data capture. It can be seen from this series of results that when the exposure time is long enough, the motion blur causes too much problem, the fringe pattern cannot be correctly captured, and thus the 3-D imaging cannot be performed. For example, if an exposure time of 2,778 microseconds, the shortest exposure time possible for a conventional system, is used, the phase map is blended together for most part, and the measurement cannot be correctly performed. This experiment clearly shows that an off-the-shelf DLP projector cannot be used to capture very fast motion when a conventional fringe generation technique is utilized. On the contrast, this new technique allows the use of such a projector for extreme fast motion capture.

It should be noted that the measurement accuracy of this system is not high at current stage because we have not found a way to calibrate the defocused projector yet. In this research, we followed a standard simple calibration approach (described in Zhang et al. 2002). This calibration technique is a linear approximation. This technique is essentially to measure a flat reference plane, find the phase difference point by point between the measured object phase the and the reference phase, and approximate the depth (z) by scaling the phase. The scaling factor is determined by measuring a known step height object. Because this is an approximation, the accuracy is not very high (Zhang et al. 2006). We have not been able to implement a high-accuracy structured light system calibration technique, such as the one introduced in Zhang et al. 2006. This is because the existing techniques require the projector be in focus, which is not the case for our system. We are exploring a new method to accurately calibrate a defocused projector, and if successful, it will significantly improve the measurement accuracy.” Even with such a simple calibration technique, we found that for a measurement area of 2″×2″, the measurement error is approximately 0.19 mm rms.

### 7.4 Discussions

By properly defocusing binary structured patterns to be sinusoidal, the DLP projector can essentially be converted into a digital solid-state fringe generation system. Because of its digital fringe generation nature, there are some advantageous features associated with it:

Superfast: Our experiment has used 80 microsecond exposure time for data capture, this means that the frame rate can go up to 12,500 Hz 3-D shape measurement rate with such an

inexpensive off-the-shelf projector. An brighter projector or better camera should be able to reach much higher frame rate 3-D shape measurement by using the same technique.

Flexible: Because the fringe patterns are generated digitally, it is easier than a mechanical grating to change the fringe patterns, e.g., fringe pitch.

Adaptable: This system can be easily converted to a phase-shifting based 3-D shape measurement system because the phase shift can be easily generated by spatially moving the binary structured patterns. In fact, we have developed a superfast 3-D shape measurement system based a similar fringe generation approach employing a faster binary structured pattern switching system (DLP Discovery D4000) (Zhang et al. 2010). We have successfully realized 3-D shape measurement speed of 667 fps using a three-step phase-shifting algorithm.

Compact: The whole system including the illuminator are packaged into the DLP projector. The DLP projector, especially the LED-based projector becomes smaller and smaller, thus the 3-D shape measurement system can be miniaturized by taking advantage of the new hardware technology.

Inexpensive: The DLP projector becomes cheaper and cheaper, there are some with a price below $200 (e.g., Optoma PK100 Pico Projector).

However, because the projector is defocused, the depth range is relatively smaller comparing with a traditional sinusoidal fringe generation technique. Another possible shortcoming is that it is theoretically not possible to generate ideal sinusoidal fringe pattern from this manner, therefore, some phase error compensation methods may be applied to reduce the associated measurement errors.

### 7.5. Conclusions

A technique that achieves unprecedentedly 3-D shape measurement speed with an off-the-shelf DLP projector is disclosed. It eliminates the speed bottleneck of a conventional

sinusoidal fringe generation technique. Because only binary structure patterns are used, with each micromirror always being one stage (ON or OFF), the exposure time can be shorter than projection time. By this means, the system can measure faster motion with high quality. Experiments have been presented to demonstrate we could achieve 3-D shape measurement speed at 4000 Hz rate with an exposure time of 80 microseconds. The speed and exposure time limits are determined by the projector output light intensity and the camera sensitivity. Even with such a projector, the 3-D shape measurement speed can be as high as 12,500 Hz if the image resolution is reduced. This proposed methodology has the potential to replace a conventional mechanical grating method for 3-D shape measurement while maintains the merits of a digital fringe generation technique.

With an off-the-shelf inexpensive DLP projector, this proposed technology reached an unprecedentedly high speed. Of course, this technology is not trouble free. Comparing with the conventional digital fringe projection technique, there are two major limitations: (1) the current measurement accuracy is lower because the approximation calibration method used in this technique is inherently lower than those absolute calibration method; and (2) the measurement range is smaller. This is because ideal sinusoidal fringe patterns only happen with a range of the distance. It is further contemplated that methodologies may be used to compensate for the residual phase error that are caused by the nonsinusoidality of the fringe patterns, and that the measurement range may be extended.

### 8. Extended Measurement Range

As previously explained, 3D shape measurement based on digital sinusoidal fringe-projection techniques has been playing an increasingly important role in optical metrology owing to the rapid advancement of digital video display technology. However, it remains challenging to use an off-the-shelf projector without calibrating its nonlinear gamma.

As previously described, by defocusing binary structured patterns, sinusoidal ones can be produced and the problems induced by nonlinear gamma can be eliminated. However, because it only uses one frequency fringe images, this technique cannot measure step height or discontinuous surfaces. To measure step-height objects, two- (Polhemus 1973), multiple- (Cheng et al. 1985), or optimum-wavelength selection (Towers et al. 2003) techniques have been proposed, essentially to increase the equivalent wavelength to measure an object with large step height. If the longest equivalent wavelength covers the entire range of measurement, arbitrary step height can be measured (Zhang 2009). There are also techniques that use wavelet-based fringe analysis to step height measurement (Quan et al. 2005). However, all these techniques require all fringe patterns to be sinusoidal and thus cannot be applied to this flexible fringe generation method because, given a degree of defocusing, it is impossible to generate high-quality sinusoidal fringe images for all structured patterns with different stripe widths.

This section introduces a technique that combines binary coding with sinusoidal phase-shifting methods to circumvent this problem. For this method, binary structured patterns are used to generate codewords, that is, to unwrap the phase point by point. Structured patterns are designed so that the codeword is unique for each phase-change period. The projector is properly defocused so that the narrowest binary patterns become sinusoidal ones and the wider ones are deformed to a certain degree. The narrowest binary patterns are spatially phase shifted for phase calculation, and the wider deformed ones are binarized to obtain the codeword. Finally, the codeword is applied to unwrap the phase point by point. Because the projector is not in focus, it causes some problems that will be addressed and handled by a, computational framework. Experiments will be presented to verify the performance of the proposed approach.

Phase-shifting methods are widely used in optical metrology because of their speed and accuracy (Malacara 2007). We use a three-step phase-shifting algorithm with a phase shift of 2π/3, and three fringe images can be written as

I₁(x,y)=I′(x,y)+I″(x,y)cos [φ(x,y)−2π/3],

I₂(x,y)=I′(x,y)+I″(x,y)cos [φ(x,y)],

I₃(x,y)=I′(x,y)+I″(x,y)cos [φ(x,y)+2π/3]

Here I′/(x, y) is the average intensity, I″(x, y) the intensity modulation, and φ(x, y), the phase to be solved for. Solving the equations simultaneously, we obtain the average intensity

I′(x,y)=(I₁+I₂+I₃)/3,

the intensity modulation

$${I}^{″} ( x , y ) = \frac{\sqrt{3 {( {I}_{1} - {I}_{3} )}^{2} + {( 2 {I}_{2} - {I}_{1} - {I}_{3} )}^{2}}}{3} ,$$

the data modulation

$${γ}^{″} ( x , y ) = \frac{\sqrt{3 {( {I}_{1} - {I}_{3} )}^{2} + {( 2 {I}_{2} - {I}_{1} - {I}_{3} )}^{2}}}{{I}_{1} + {I}_{2} + {I}_{3}} ,$$

and the phase

$$φ ( x , y ) = {tan}^{- 1} [ \frac{\sqrt{3} ( {I}_{1} - {I}_{3} )}{2 {I}_{2} - {I}_{1} - {I}_{3}} ]$$

where I′(x, y)_is the average intensity, I″(x, y) is the intensity modulation, and φ(x, y) is the phase to be solved for. Simultaneously solving the above equations, the phase can be obtained:

$$φ ( x , y ) = {tan}^{- 1} [ \frac{\sqrt{3} ( {I}_{1} - {I}_{3} )}{2 {I}_{2} - {I}_{1} - {I}_{3}} ]$$

This equation provides the wrapped phase with 2π discontinuities. A spatial phase-unwrapping algorithm can be applied to obtain continuous phase (Ghiglia et al. 1998). The phase unwrapping is essentially to detect the 2π discontinuities and remove them by adding or subtracting multiple times of 2π point by point. In other words, the phase unwrapping is to find integer number k(x, y) so that

Φ(x,y)=φ(x,y)+k(x,y)×2π.

Here, Φ(x, y) denotes the unwrapped phase.

Instead of using a conventional phase-unwrapping algorithm, a binary coding method can be adopted to determine integer k(x,y) (Sansoni et al. 1999). For this method, a sequence of binary images (Iₖ^{b}(x, y)) are used to obtain the codeword that is designed to be same as k(x,y). However, unlike the system introduced in Sansoni et al. (1999), the projector is defocused in our system, and other issues are addressed.

FIG. 30 illustrate the schematic diagram for the proposed method. The computer generates a set of binary patterns, with three narrowest ones being shifted spatially. These patterns are sent to a defocused projector. The projector is properly defocused so that the narrowest binary patterns become ideal sinusoidal, while the wider ones are deformed to a certain degree. Three sinusoidal fringe patterns are used to compute the phase, while the wider ones are binarized to obtain the codeword k(x, y) for phase unwrapping.

Because the object surface might not be uniform, it is necessary to normalize the structured images for codeword generation before binarization. The maximum and minimum intensity can be obtained pixel by pixel; they are

Iₘᵢₙ₍x,y)=I′(x,y)−I″(x,y),

Iₘₐₓ₍x,y)=I′(x,y)−I″(x,y).

The binary images Iₖ^{b}(x, y) can be normalized by equation

Iₖ^{nb}(x,y)=(Iₖ^{b}−Iₘᵢₙ)/(Iₘₐₓ−Iₘᵢₙ).

This proposed method is tested by a fringe projection system that includes a Dell LED projector (M109S) and The Imaging Source digital USB CCD camera (DMK 21BU04) with a Computar M3514-MP lens F/1.4 with f=8 mm. The camera resolution is 640×480. The projector resolution is 858×600, and the projection lens has F/2.0 and f=16.67 mm.

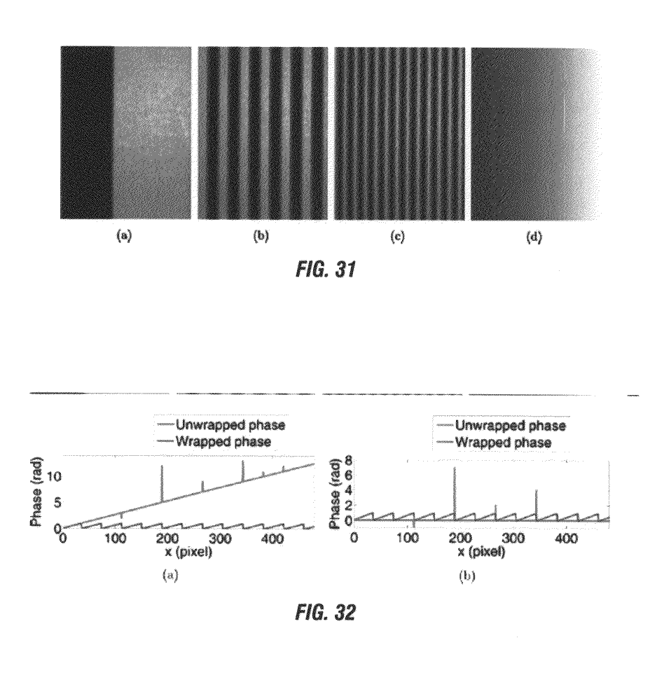

We first measure a uniform white flat surface. FIG. 31, panel (a) and 31, panel (b) respectively show the widest and narrowest binary images, and FIG. 31(c) shows one of the phase-shifted sinusoidal fringe images. With this set of structured images, the unwrapped phase can be obtained, as shown in FIG. 31, panel (d). However, the phase map clearly shows some problems: undesirable noises. This problem is caused mostly by the defocused projector and the discrete sampling camera. The phase jumps may shift left or right a half pixel owing to the projector defocusing, and the codeword changes may not align with the phase changes, because the camera is a discrete device.

FIG. 32 shows one cross section of the unwrapped phase map [shown in FIG. 31, panel (d)] and the cross section of the wrapped phase. It indicates that the problematic points occur only to the phase discontinuous neighboring points. To solve this new problem, we developed a computational framework that is divided into three steps: (1) detect and mask incorrect points during binarization stage by referring to the wrapped phase map; (2) identify and mask incorrect binary code points by applying monotonic conditions; and (3) unwrap the masked points applying surface smoothness condition.

Step 1: This step applies to the binarization stage. On the binary image, we identify the binary change points and compute the phase difference between them using the wrapped phase map. If it is less than it, the point is marked as incorrect and will be post processed. Because the codeword is designed to change with the 2π discontinuous places, if the real image does not satisfy this condition, the codeword should be wrong.
Step 2: Because of the design of the digital fringe projection system, the phase map projected by the projector and captured by the camera should be monotonically changing a cross the fringe stripes. Because those incorrect points are sparse points that are close to the phase discontinuous positions, it is feasible to identify them and mark them as incorrect points for further processing by comparing each with its neighboring pixels.
Step 3: For those points require further processing, an additional phase-unwrapping stage is applied. This phase unwrapping applies only locally, from −N to +N points across the fringe stripes. The phase unwrapping is to find integer number k for each masked point (i₀, j₀) to minimize functional

$${\sum }_{n = - N}^{n = N} \{ Φ ( {i}_{0} , {j}_{0} + n ) - [ φ ( {i}_{0} , {j}_{0} ) + k \times 2 π ] \} ,$$

assuming the fringe stripe is vertical. The unwrapped phase for (i₀, j₀) point is then

Φ=φ+2kπ.

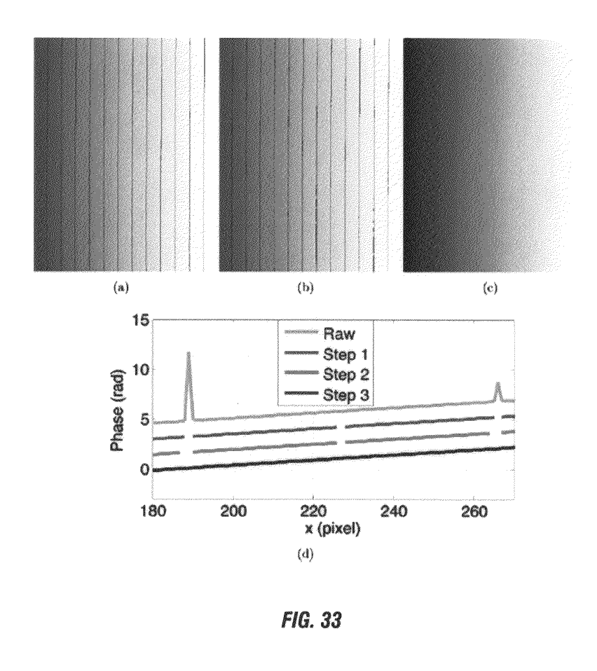

FIG. 33 shows the results after applying each step for the phase map shown in FIG. 31, panel (d). FIG. 33, panel(d) shows one cross section of these phase maps. It should be noted that only a segment of points are displayed and phases are shifted vertically on purpose to better visualize the differences between each step. It clearly shows that the proposed phase computational framework can successfully remove the induced problems.

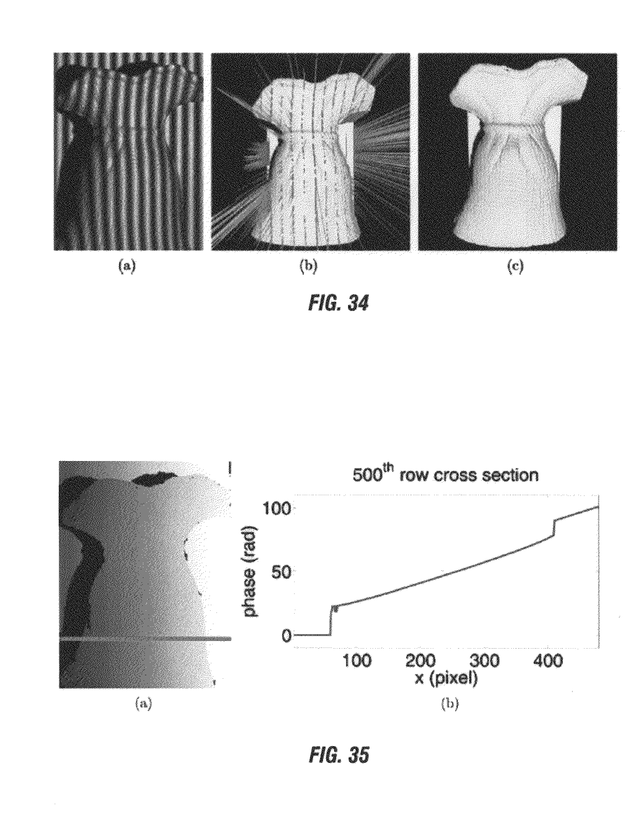

To verify the performance of this proposed algorithm, a more complex object sitting in front of a flat white board is measured. FIG. 34 shows the measurement result. Whereas FIG. 34, panel (a) shows one of the sinusoidal fringe patterns, FIG. 34, panel (b) shows the measurement result before applying the proposed computational framework. It clearly shows significant errors (spikes in the image). FIG. 34, panel (c) shows the result after applying the proposed computation framework. Almost all spikes are gone, and the 3-D shape is correctly recovered. It should be noted that the shadow areas in this example are masked out before any processing. The mask is determined from the fringe quality; for a low-quality fringe point, it is treated as a background. The fringe quality is determined by (1) the intensity of the average image, I′(x, y), and (2) the data modulation I″(x,y)/I′(x,y). A foreground point should have high intensity and should have close to 1 data modulation value.

Because the sculpture and the flat board are separate, this experiment also demonstrated that the proposed approach can measure step height or discontinuous objects. FIG. 35, panel (a) shows the unwrapped phase map, and FIG. 35, panel (b) shows one of its cross section (the horizontal line) in the left image; it clearly shows that the phase jumps between some points are far more than 2 π. It should be noted that the shadow or the background points are treated as phase value 0.

This section has presented a technique to extend the measurement range (i.e., step-height objects and discontinuous surfaces) of the previously proposed flexible 3-D shape measurement technique based on projector defocusing effect. Experiments have verified the feasibility of the proposed approach and the computational framework to handle the phase unwrapping problems introduced by the projector defocusing.

### 9. Options, Variations, and Alternatives

A method of 3D shape measurement has thus been disclosed. The method may include generating sinusoidal fringe patterns by defocusing binary patterns. Such a ground-breaking method has the potential to reach very high-speed 3D shape measurement. There is no way for conventional 3D fringe generation method to reach tens of kHz 3D shape measurement because the complexity of generating and shifting spatially from frame to frame. Thus, this aspect of the present invention provides for unexpected, surprising, and remarkable results. In addition, because DLP technology (which may be used) is inherently binary image generation, using the binary pattern is the natural choice, and has the potential to reach its extreme image switching speed, tens of kHz, even MHz.

The potential for unprecedented speed makes the present invention suitable for applications which heretofore, could not be considered. For example, the present invention is suitable for use in 3D surface sensing of moving objects in real-time.

The methodology of the present invention may be implemented in numerous applications and for numerous purposes. The present invention may be also be used in diverse applications such as security, entertainment, and other types of imaging. Although specific embodiments have been described throughout the present application, the present invention is not to be limited to these specific embodiments. In addition, the present invention may include various aspects that are independent from each other and no single embodiment need include all aspects of the invention.

The various aspects of the present invention may be used in numerous applications including medical science, forensic sciences, computer graphics, infrastructure health monitoring, biometrics, and homeland security, virtual reality, and manufacturing and quality control. Of course, within each of these disparate fields there are many different potential applications for the present invention. Of course, the present invention is in no way to limited to these specific fields or applications.

### 8. REFERENCES

Various references have been cited throughout this application. Each of these references is incorporated by reference in its entirety.
Besl, P. & McKay, N. (1992), “A method for registration of 3-d shapes”, IEEE Trans. on Patt. Analy. and Mach. Intel. 14, 239-256.
Bray, M.-A., Lin, S.-F. & Wikswo, J. P. (2000), “Three-dimensional surface reconstruction and fluorescent visualization of cardiac activation”, IEEE Trans. Biomed. Eng. 47, 1382-1390.
Chazan, G. & Kiryati, N. (1995), “Pyramidal intensity-ratio depth sensor,” Tech. Rep. No. 121, Israel Institute of Technology, Technion, Haifa, Israel (1995).
Chen, Y. & Medioni, G. (1992), “Object modeling by registration of multiple range images”, Image Vision Comput. 10, 145-155.
Cheng, Y.-Y. & Wyant, J. C. (1984), “Two-wavelength phase shifting interferometry,” Appl. Opt. 23, 4539-4543.
Cheng, Y.-Y. & Wyant, J. C. (1985), Multiple-wavelength phase shifting interferometry,” Appl. Opt. 24, 804-807 (1985).
Creath, K. (1987), “Step height measurement using two-wavelength phase-shifting interferometry”, Appl. Opt. 26, 2810-2816.
Davis, J., Ramamoorthi, R., Rusinkiewicz (2005), “Spacetime stereo: A unifying framework for depth from triangulation,” IEEE Trans. Patt. Anal. And Mach.e Intell. 27, 1-7 (2005).
Decker, J. E., Miles, J. R., Madej, A. A., Siemsen, R. F., Siemsen, K. J., d. Bonth, S., Bustraan, K., Temple, S. & and Pekelsky, J. R. (2003), “Increasing the range of unambiguity in step-height measurement with multiple-wavelength interferometry-application to absolute long gauge block measurement,” Appl. Opt. 42, 5670-5678 (2003).
Dhond, U. & Aggarwal, J. (1989), “Structure from stereo-a review”, IEEE Trans. Systems, Man, and Cybernetics 19(6), 1489-1510.
Efimov, I. R., Nkolski, V. P. & Salama, G. (2004), “Optical imaging of the heart”, Circulation Research 95(1), 21-33.
Evertson, D. W., Holcomb, M. R., Eames, M. D. C., Bray, M.-A., Sidorov, V. Y., Xu, J., Wingard, H., Dobrovolny, H. M., Woods, M. C., Gauthier, D. J. & Wikswo, J. P. (2008), “High-resolution high-speed panoramic cardiac imaging system”, IEEE Trans. Biomed. Eng. 55(3), 1241-1243.
Geng, Z. J. (1996), “Rainbow 3-d camera: New concept of high-speed three vision system”, Opt. Eng. 35, 376-383.
Ghiglia, D. C. & Pritt, M. D. (1998), Two-Dimensional Phase Unwrapping: Theory, Algorithms, and Software, John Wiley and Sons, Inc.
Gorthi, S. & Rastogi, P. (2010), “Fringe projection techniques: Whither we are?”, Opt. Laser. Eng. 48, 133-140.
Grimm, C. (2005), “Spherical manifolds for adaptive resolution surface modeling”, in Graphite.
Gu, X., Zhang, S., Huang, P., Zhang, L., Yau, S.-T. & Martin, R. (2006), “Holoimages”, in Proceedings of the 2006 ACM symposium on Solid and physical modeling, 129-138.
Guo, H., He, H. & Chen, M. (2004), Appl. Opt. 43, 2906. “Gamma Correction for Digital Fringe Projection Profilometry,” Appl. Opt. 43, 2906-2914.
Hall-Holt, O. & Rusinkiewicz, S. (2001), “Stripe boundary codes for real-time structured-light range scanning of moving objects”, in The 8th IEEE International Conference on Computer Vision, II: 359-366.
Harding, K. G. (1991), “Phase grating use for slop discrimination in moiré contouring”, in Proc. SPIE, 1614, 265-270.
Hornbeck, L. J. (1997), “Digital light processing for high-brightness, high-resolution applications,” in Proc. SPIE, vol. 3013, pp. 27-40 (1997).
Hu, Q., Harding, K. G., Du, X. & Hamilton, D. (2005), “Shiny parts measurement using color Separation”, in SPIE Proc., 6000, 6000D1-8.
Huang, P. S., Hu, Q., Jin, F. & Chiang, F. P. (1999), “Color-encoded digital fringe projection technique for high-speed three-dimensional surface contouring”, Opt. Eng. 38, 1065-1071.
Huang, P. S. & Zhang, S. (2006), “Fast three-step phase shifting algorithm”, Appl. Opt. 45, 5086-5091.
Huang, P. S., Zhang, S. & Chiang, F.-P. (2005) “Trapezoidal phase-shifting method for three-dimensional shape measurement,” Opt. Eng. 44, 123601.
Huang, P. S., Zhang, S. & Chiang, F.-P. (2003) “High-speed 3-D shape measurement based on digital fringe projection,” Opt. Eng. 42, 163-168.
Jia, P., Kofman, J. & English, C. (2007), “Two-step triangular-pattern phase-shifting method for three-dimensional object-shape measurement,” Opt. Eng. 46, 083201.
Jones, A., McDowall, I., Yamada, H., Bolas, M. & Debevec, P. (2007), “Rendering for an interactive 360° light field display”, in ACM SIGGRAPH, 40.
Kay, M. W., Amison, P. M. & Rogers, J. M. (2004), “Three-dimensional surface reconstruction and panoramic optical mapping of large hearts”, IEEE Trans. Biomed. Eng. 51, 1219-1229.
Lei, S. & Zhang, S. (2009), “Flexible 3-D shape measurement using projector defocusing,” Opt. Lett. 34, 3080-3082 (2009).
Lin, S. F. & Wikswo, J. P. (1999), “Panoramic optical imaging of electrical propagation in isolated heart”, J. Biomed. Opt. 4, 200-207.
Lohry, W., Xu, Y., Bodnar, B., & Zhang, S. (2009), “Optimum Checkerboard Selection for Structured Light System Calibration”, In SPIE Optics and Photonics Conference (to Appear).
Lou, Q., Ripplinger, C. M., Bayly, P. V. & Efimov, I. R. (2008), “Quantitative panoramic imaging of epicardial electrical activity”, Annals Biomed. Eng. 36, 1649-1658.
Malacara, D., ed. (2007), Optical Shop Testing, 3^{rd} Ed., John Wiley and Songs, New York.
McDowall, I. & Bolas, M. (2005), Display, sensing, and control applications for digital micromirror displays, In IEEE VR 2005—Emerging Display Technologies, 35-36.
Mehta, D. S., Dubey, S. K., Shakher, C. & Takeda, M. (2006), “Two-wavelength talbot effect and its application for three-dimensional step-height measurement,” Appl. Opt. 45, 7602-7609.
Narasimhan, S. G., Koppal, S. J., Yamazaki, S. (2008), “Temporal Diethering of Illumination for Fast Active Vision,” Lecture Notes in Computer Science 5305, 830-844.
Pan, B., Kemao, Q., Huang, L. & Asundi, A. (2009), Opt. Lett. 34, 2906.
Pan, J., Huang, P., Zhang, S. and Chiang, F.-P. (2004), “Color n-ary gray code for 3-d shape measurement,” in Proc. 12th Int'l Conference on Experimental Mechanics.
Polhemus, C. (1973) “Two-wavelength interferometry,” Appl. Opt. 12, 2071-2074.
Qu, F., Ripplinger, C. M., Nikolski, V. P., Grimm, C. & Efimov, I. R. (2007), “Three-dimensional panoramic imaging of cardiac arrhythmias in rabbit heart”, J. Biomed. Opt. 12, 044019.
Quan, C., Fu, Y., Tay, C. J., Tan, J. M. (2005) Appl. Opt. 44, 3284.
Rogers, J. M., Walcott, G. P., Gladden, J. D., Melnick, S. B. & Kay, M. W. (2007), “Panoramic optical mapping reveals continuations epicardial reentry during ventricular fibrillation in the isolated swine heart”, Biophys. 92, 1090-1095.
Roy, M., Sheppard, C. J. R., Cox, G. & and Hariharan, P. (2006), “White-light interference microscopy: a way to obtain high lateral resolution over an extended range of heights,” Opt. Express 14, 6788-6793.
Rusinkiewicz, S., Hall-Holt, O. & Levoy, M. (2002), “Real-time 3d model acquisition”, ACM Trans. Graph. 21(3), 438-446.
Rusinkiewicz, S. & Levoy, M. (2001), “Efficient variants of the ICP algorithm”, in Third International Conference on 3D Digital Imaging and Modeling (3DIM).
Salvi, J., Fernandez, S., Pribanic, T., Llado, X. (2010), “State of the art in structured light patterns for surface profilometry”, Patt. Recogn. 43, 2666-2680.
Salvi, J., Pages, J. & Batlle, J. (2004), “Pattern codification strategies in structured light systems”, Pattern Recognition 37(4), 827-849.
Sansoni, G., Carocci, M. and Rodella, R. (1999), “Three-dimensional vision based on a combination of gray-code and phase-shift light projection: analysis and compensation of the systematic errors,” Appl. Opt. 38(31).
Schreiber, H. & Bruning, J. H. (2007), Optical Shop Testing, ch. 14, 547-666. John Wiley & Sons, 3rd ed.
Su, X. Y., Zhang, Q. (2010), “Dynamic 3-D shape measurement method: A review,” Opt. Laser Eng. 48, 191-204 (2010).
Su, X. Y., Zhou, W. S., Von Bally, G., Vukivevic, D. (1992), “Automated phase-measuring profilometry using defocused projection of a Ronchi grating.” Opt. Commun. 94, 561-573.
Takeda, M. & Mutoh, K. (1983) “Forier transform profilometry for the atomatic measurement of 3-D object shape,” Appl. Opt. 22, 3977-3982.
Takeda, M. (2010), “Measurements of extreme physical phenomena by Fourier fringe analysis,” in AIP Conference Proc., vol. 1236, pp. 445-448 (2010).
Towers, C. E., Towrs, D. P., Jones, J. D. C., Opt. Lett. 28, 887 (2003).
Wang, Z., Du, H., Park., S., Xie, H. (2009) “Three-dimensional shape measurement with a fast and accurate approach,” Appl. Opt. 48, 1052-1061.
Warnasooriya, N. & Kim, M. K. (2007) “Led-based multi-wavelength phase imaging interference microscopy,” Opt. Express 15, 9239-9247.
Yoshinori, Y., Hiroyuki, M., Osamu, N. & Tetsuo, I. (2003), “Shape measurement of glossy objects by range finder with polarization optical system”, Gazo Denshi Gakkai Kenkyukai Koen Yoko (in Japanese) 200, 43-50.
Zhang, C., Huang., P. S., Chiang, F.-P. (2002), “Microscopic phase-shifting profilometry based on digital micromirror device technology.” Appl. Opt. 41, 5896-5904.
Zhang, L., Curless, B. & Seitz, S. M. (2002), “Rapid shape acquisition using color structured light and multi-pass dynamic programming”, in The 1st IEEE Intl Symp. 3D Data Proc., Vis., and Trans., 24-36.
Zhang, S. (2009), Proc. SPIE 7432, 74320N.
Zhang, S. (2010a), “Recent progresses on real-time 3-D shape measurement using digital fringe projection techniques,” Opt. Laser Eng. 40, 149-158.
Zhang, S. (2010b), Advances in measurement systems, chap. 2, pp. 29-50 (In-Tech, 2010).
Zhang, S. & Huang, P. S. (2004), “High-resolution, real-time 3D shape acquisition”, IEEE Comp. Vis. Patt. Recogn. Workshop, 3, 28-37.
Zhang, S. & Huang, P. S. (2006a), “High-resolution, real-time three-dimensional shape measurement”, Opt. Eng. 45, 123601.
Zhang, S. & Huang, P. S. (2006b), “Novel method for structured light system calibration”, Opt. Eng 45, 083601.
Zhang, S., Li, X. & Yau, S.-T. (2007), “Multilevel quality-guided phase unwrapping algorithm for real-time three-dimensional shape reconstruction”, Appl. Opt. 46, 50-57.
Zhang, S., van der Weide, D., Oliver, J. (2010), “Superfast phase-shifting method for 3-D shape measurement,” Opt. Express 18, 9684-9689.
Zhang, S. & Yau, S.-T. (2006), “High-resolution, real-time 3d absolute coordinate measurement based on a phase-shifting method”, Opt. Express 14, 2644-2649.
Zhang, S. & Yau, S.-T. (2007), “High-speed three-dimensional shape measurement using a modified two-plus-one phase-shifting algorithm’, Opt. Eng. 46(11), 113603.
Zhang, S. & Yau, S.-T. (2008), “Three-dimensional data merging using holoimage”, Opt. Eng. 47, 033608.
Zhang, S. & Oliver, J. (submitted), “Hybrid method for three-dimensional shape measurement”, Appl. Opt.
Zhang, S. & Lei, S. (2010), “Digital sinusoidal fringe pattern generation: Defocusing binary patterns VS focusing sinusoidal patterns”, Optics and Lasers in Engineering 48, 561-569. Zhang, Z. (1994), “Iterative point matching for registration of free-form curves and surfaces”, Intl J. of Comp. Vis. 13, 119-152.
Zhang, Z. (2000), “A flexible new technique for camera calibration”, IEEE Trans. on Patt. Anal. and Mach. Intell. 22(11), 1330-1334.

What is claimed is:

1. A method for three-dimensional shape measurement, comprising:
generating sinusoidal fringe patterns by projecting defocused binary patterns onto an object to thereby produce phase-shifted fringe patterns;
capturing images of the object with the phase-shifted fringe patterns produced thereon; and
evaluating the images for use in the three-dimensional shape measurement.

2. The method of claim 1 wherein the projecting being performed using a digital micro mirror device (DMD) based projection system.

3. The method of claim 2 wherein the digital micro mirror device (DMD) based projection system comprises a digital light processing (DLP) projector.

4. The method of claim 1 wherein the object is in motion.

5. The method of claim 1 wherein the method being performed in real-time.

6. The method of claim 1 wherein the evaluating comprises
(a) obtaining codewords from the binary patterns;
(b) calculating a wrapped phase map from the phase-shifted fringe patterns;
(c) applying the codewords to the wrapped phase map to produce an unwrapped phase map; and
(d) computing coordinates using the unwrapped phase map for use in the three-dimensional shape measurement of the at least one object.

7. A method for three-dimensional shape measurement, comprising:
(a) projecting a plurality of binary patterns onto at least one object;
(b) projecting three phase-shifted fringe patterns onto the at least one object;
(c) capturing images of the at least one object with the binary patterns and the phase-shifted fringe patterns;
(d) obtaining codewords from the binary patterns;
(e) calculating a wrapped phase map from the phase-shifted fringe patterns;
(f) applying the codewords to the wrapped phase map to produce an unwrapped phase map; and
(g) computing coordinates using the unwrapped phase map for use in the three-dimensional shape measurement of the at least one object.

8. The method of claim 7 wherein the at least one object is a plurality of objects.

9. The method of claim 7 further comprising constructing a view of the at least one object using the coordinates.

10. The method of claim 9 wherein the steps (a)-(g) are repeated using multiple projectors and multiple cameras and wherein the view is a panoramic view.

11. The method of claim 7 wherein the at least one object comprises biological tissue in motion.

12. The method of claim 11 wherein the biological tissue includes a heart.

13. The method of claim 7 wherein the steps of (a)-(g) are performed in real-time.

14. The method of claim 7 wherein the steps are performed by a system comprising at least one projector, at least one camera, and at least one system processor operatively connected to the at least one projector and the at least one camera.

15. The method of claim 7 further comprising correcting incorrectly unwrapped points by computing a gradient of the wrapped phase map.

16. A system for three-dimensional shape measurement, comprising:
at least one projector;
at least one camera;
at least one system processor;
wherein the system being configured to perform steps of (a) generating sinusoidal fringe patterns by projecting defocused binary patterns onto an object to thereby produce phase-shifted fringe patterns, (b) capturing images of the object with the phase-shifted fringe patterns produced thereon, and (c) evaluating the images for use in the three-dimensional shape measurement.

17. The system of claim 16 wherein the at least one object is a plurality of objects.

18. The system of claim 16 wherein the system being further configured for constructing a view of the at least one object using the coordinates.

19. The system of claim 16 wherein the at least one projector comprises a plurality of projectors and the at least one camera comprises a plurality of cameras, the plurality of projectors and the plurality of cameras being arranged to provide for obtaining a panoramic view of the at least one object.

20. The system of claim 16 wherein the at least one object comprises biological tissue in motion.

21. The system of claim 16 wherein the biological tissue includes a heart.

22. The system of claim 16 wherein the system processor being further configured for correcting incorrectly unwrapped points by computing a gradient of the wrapped phase map.

23. A system for three-dimensional shape measurement, comprising:
at least one projector;
at least one camera;
at least one system processor;
wherein the system being configured to perform steps of (a) projecting a plurality of binary patterns onto at least one object, (b) projecting three phase-shifted fringe patterns onto the at least one object, (c) capturing images of the at least one object with the binary patterns and the phase-shifted fringe patterns, (d) obtaining codewords from the binary patterns, (e) calculating a wrapped phase map from the phase-shifted fringe patterns, (f) applying the codewords to the wrapped phase map to produce an unwrapped phase map, and (g) computing coordinates using the unwrapped phase map for use in the three-dimensional shape measurement of the at least one object.

24. A method for three-dimensional shape measurement, comprising generating sinusoidal fringe patterns by defocusing binary patterns.

25. The method of claim 24 further comprising projecting the sinusoidal fringe patterns onto at least one object.

26. The method of claim 25 further comprising capturing images of the at least one object with the sinusoidal fringe patterns.

27. The method of claim 26 further comprising evaluating the images for use in the three-dimensional shape measurement.

28. The method of claim 25 wherein the projecting being performed using a digital micro mirror device (DMD) based projection system.

29. The method of claim 25 wherein the digital micro mirror device (DMD) based projection system comprises a digital light processing (DLP) projector.

30. The method of claim 25 wherein the at least on object being in motion.

31. The method of claim 27 wherein the evaluating being performed using a graphics processing unit (GPU).

32. A system for three-dimensional shape measurement, comprising:
at least one projector;
at least one camera;
at least one system processor; and
wherein the system being configured to generate sinusoidal fringe patterns by defocusing binary patterns, projecting the sinusoidal fringe patterns onto at least one object, capturing images of the at least one object with the sinusoidal fringe patterns, and evaluating the images to provide for three-dimensional shape measurement of the at least one object.

33. The system of claim 32 wherein the at least one projector includes a digital micro mirror device (DMD) based projection system.

34. The system of claim 33 wherein the digital micro mirror device (DMD) based projection system includes a digital light processing (DLP) projector.

35. The system of claim 32 wherein the system processor includes at least one graphics processing unit (GPU).
